(19) United States
(12) Patent Application Publication
(10) Pub. No.: US 2025/0182352 A1
(43) Pub. Date: Jun. 5, 2025

(54) VISUAL DATA ANALYSIS METHOD AND DEVICE

(71) Applicant: BOE Technology Group Co., Ltd., Beijing (CN)

(72) Inventors: Li WANG, Beijing (CN); Weihua LI, Beijing (CN); Ang LI, Beijing (CN)

(21) Appl. No.: 18/862,033

(22) PCT Filed: Apr. 27, 2023
(86) PCT No.: PCT/CN2023/091384

§ 371 Date: Oct. 31, 2024

(30) Foreign Application Priority Data
Jun. 29, 2022 (CN) 202210760354.0

(51) Int. Cl. G06T 11/20; G06F 16/2455; G06F 16/248

(52) U.S. Cl. CPC G06T 11/206; G06F 16/2455; G06F 16/248

(57) ABSTRACT

The present disclosure provides a visual data analysis method and device used for visual analysis for multiple types of data sources. By establishing connection relationships with various types of data sources, multiple types of data sources can be obtained in real time, and various types of data sources are combined and analyze in real time. The method includes: obtaining multiple types of data sources, and establishing a connection with each type of data source, wherein the type of data source is used to represent a source from which data is obtained; displaying, through a visual page, each piece of table information contained in each type of data source with which the connection is made.

### CROSS-REFERENCE TO RELATED APPLICATION

The present disclosure is a National Stage of International Application No. PCT/CN2023/091384, filed on Apr. 27, 2023, which claims priority to Chinese patent application No. 202210760354.0, filed to China National Intellectual Property Administration on Jun. 29, 2022, the entire content of which are incorporated herein by reference.

### TECHNICAL FIELD

The present disclosure relates to the field of data analysis technology, and in particular to a visual data analysis method and device.

### BACKGROUND

In recent years, various companies have been building visual data analysis systems, and most of the visualization platforms currently built are implemented for a specific data source. The development of big data has brought about the diversification of data. The source of data is not only obtained from the database, but also from external open interfaces, and temporary cache data during the operation of some products, etc. These data can be solidified in certain ways into the database for visual display through the database visualization system.

However, the manner of obtaining data from the open interface or from the temporary cache and solidifying it into a database not only occupies the storage resources of the visualization system, but is also not conducive to the massive data analysis on the cloud platform.

### SUMMARY

The present disclosure provides a visual data analysis method and device used for visual analysis for multiple types of data sources. By establishing connection relationships with various types of data sources, multiple types of data sources can be obtained in real time, and various types of data sources are combined and analyze in real time.

In the first aspect, embodiments of the present disclosure provide a visual data analysis method, including: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

As an optional implementation, obtaining multiple types of data sources through any one or more of following manners: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, obtaining a data source of a corresponding type according to the parameter information through any one or more of following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the obtaining a data source of a corresponding type through a file transfer protocol, includes: obtaining a file in a file transfer protocol (FTP) server by means of a secret file transfer protocol (SFTP), and determining the file obtained as a data source of a FTP type.

As an optional implementation, the using an executed SQL statement as an obtained data source of a corresponding type, includes: receiving a SQL statement executed by the user on a data source with which a connection is made, and determining the executed SQL statement as a data source of a SQL statement type.

As an optional implementation, the establishing a connection with each type of data source, includes: establishing a connection with each type of data source according to connection information of each type of data source.

As an optional implementation, the establishing a connection with each type of data source according to connection information of each type of data source, includes: writing the connection information of each type of data source into a configuration file of a distributed query engine; and when starting the distributed query engine, establishing, according to the connection information of each type of data source in the configuration file, the connection with each type of data source.

As an optional implementation, when the data source is a data source of a database type, the establishing a connection with each type of data source according to connection information of each type of data source, includes: establishing a connection with the data source of the database type according to a database parameter, wherein the database parameter represents a parameter required to connect with a database.

As an optional implementation, when the data source is a data source of an interface type, the establishing a connection with each type of data source according to connection information of each type of data source, includes: running an interface according to an interface parameter to obtain Java script object notation (JSON) data, and parsing the JSON data to obtain a data source parameter; and establishing a connection with the data source of the interface type according to the data source parameter parsed and the interface parameter.

As an optional implementation, when the data source is a data source of a text type, the establishing a connection with each type of data source according to connection information of each type of data source, includes: determining a data source parameter according to a data source stored in a file storage server; and establishing a connection with the data source of the interface type according to a server parameter of the file storage server and the data source parameter.

As an optional implementation, the data source parameter includes at least one of a data source identifier, a type of data source, a library field, a table field, a column field, or a field type of a column field.

As an optional implementation, when the data source is a data source of a SQL statement type, the establishing a connection with each type of data source according to connection information of each type of data source, includes: performing a syntax verification on a SQL statement, and after determining that the syntax verification passes, parsing the SQL statement to obtain table information in the SQL statement; and establishing a connection with the data source of the SQL statement type according to the SQL statement and the table information in the SQL statement.

As an optional implementation, after parsing the SQL statement to obtain table information in the SQL statement, the method further includes: storing the SQL statement and the table information in the SQL statement in a local database; and generating a nested SQL statement using the stored SQL statement and a SQL statement input by the user, and determining the generated nested SQL statement as an obtained data source of the SQL statement type.

As an optional implementation, the establishing a connection with each type of data source, includes: building a shared data source application according to a connection pool of each data source contained in each type of data source; and establishing a connection between each business system and each type of data source through the shared data source application, wherein the shared data source application provides a service for each business system to connect with each type of data source through an ability for integrating a connection with each type of data source.

As an optional implementation, the establishing a connection between each business system and each type of data source through the shared data source application, includes: establishing a connection between the shared data source application and each type of data source according to connection information of each data source described in a metadata; and establishing a connection between each type of data source connected with the shared data source application and each business system through the shared data source application.

As an optional implementation, the establishing a connection between each business system and each type of data source through the shared data source application, includes: receiving an access requirement of each business system through the shared data source application; determining a connection pool of a target data source corresponding to each business system according to the access requirement of each business system and a number of connections in a connection pool of each data source; and establishing a connection between each business system and a corresponding target data source through the connection pool of the target data source.

As an optional implementation, after the establishing a connection between each business system and each type of data source through the shared data source application, the method further includes: receiving an operation instruction sent by the business system in a form of a metadata through the shared data source application; and performing at least one operation of aggregation, filtering, or query on a data source corresponding to the operation instruction.

As an optional implementation, in response to an association operation of a user on multiple tables that are displayed, the generating a target dataset according to an association relationship between the multiple tables indicated by the association operation, includes: in response to a dragging instruction of the user for the multiple tables displayed, determining table information of each target table corresponding to the dragging instruction; and receiving an association relationship between multiple target tables input by the user, and generating a target dataset according to the table information of each target table and the association relationship.

As an optional implementation, the generating a target dataset according to the table information of each target table and the association relationship, includes: determining first fields, that are the same, between the multiple target tables and second fields that are retained after the multiple target tables are associated according to the association relationship; and generating a SQL statement according to the table information of each target table, the first fields and the second fields, and executing the SQL statement to obtain the target dataset.

As an optional implementation, the generating a target dataset according to the table information of each target table and the association relationship, further includes: receiving a filtering condition input by the user, wherein the filtering condition is used to filter data in multiple target tables; and generating a target dataset according to the filtering condition, table information of the multiple target tables, and the association relationship between the multiple target tables.

As an optional implementation, the displaying the target dataset on the visual page by means of a chart, includes: determining a chart type specified by the user and a target data column in the target dataset; using the target data column as chart data corresponding to the chart type, and using a chart component to draw a chart corresponding to the chart type; and displaying the drawn chart on the visual page.

In the second aspect, embodiments of the present disclosure further provide a visual data analysis system, including a display and a controller: the display is configured to implement a human-computer interaction with a user through an interactive interface and display a visual page; the controller is configured to perform following operations based on the human-computer interaction: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

As an optional implementation, the controller is specially configured to obtain multiple types of data sources through any one or more of following manners: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the controller is specially configured to obtain a data source of a corresponding type according to the parameter information through any one or more of following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the controller is specially configured to: obtain a file in a FTP server by means of a SFTP, and determine the file obtained as a data source of a FTP type.

As an optional implementation, the controller is specially configured to: receive a SQL statement executed by the user on a data source with which a connection is made, and determine the executed SQL statement as a data source of a SQL statement type.

As an optional implementation, the controller is specially configured to: establish a connection with each type of data source according to connection information of each type of data source.

As an optional implementation, the controller is specially configured to: write the connection information of each type of data source into a configuration file of a distributed query engine; and when starting the distributed query engine, establish, according to the connection information of each type of data source in the configuration file, the connection with each type of data source.

As an optional implementation, when the data source is a data source of a database type, the controller is specially configured to: establish a connection with the data source of the database type according to a database parameter, wherein the database parameter represents a parameter required to connect with a database.

As an optional implementation, when the data source is a data source of an interface type, the controller is specially configured to: run an interface according to an interface parameter to obtain JSON data, and parse the JSON data to obtain a data source parameter; and establish a connection with the data source of the interface type according to the data source parameter parsed and the interface parameter.

As an optional implementation, when the data source is a data source of a text type, the controller is specially configured to: determine a data source parameter according to a data source stored in a file storage server; and establish a connection with the data source of the interface type according to a server parameter of the file storage server and the data source parameter.

As an optional implementation, the data source parameter includes at least one of a data source identifier, a type of data source, a library field, a table field, a column field, or a field type of a column field.

As an optional implementation, when the data source is a data source of a SQL statement type, the controller is specially configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation, after parsing the SQL statement to obtain table information in the SQL statement, the controller is specially configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the controller is specially configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the controller is specially configured to: establish a connection between the shared data source application and each type of data source according to connection information of each data source described in a metadata; and establish a connection between each type of data source connected with the shared data source application and each business system through the shared data source application.

As an optional implementation, the controller is specially configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation, after the establishing a connection between each business system and each type of data source through the shared data source application, the controller is specially configured to: receive an operation instruction sent by the business system in a form of a metadata through the shared data source application; and perform at least one operation of aggregation, filtering, or query on a data source corresponding to the operation instruction.

As an optional implementation, the controller is specially configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the controller is specially configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the controller is specially configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the controller is specially configured to: determine a chart type specified by the user and a target data column in the target dataset; use the target data column as chart data corresponding to the chart type, and use a chart component to draw a chart corresponding to the chart type; and display the drawn chart on the visual page.

In the third aspect, embodiments of the present disclosure provide a visual data analysis device, includes a processor and a memory, the memory is configured to store programs executable by the processor, and the processor is configured to read the programs in the memory and execute followings: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

As an optional implementation, the processor is specially configured to obtain multiple types of data sources through any one or more of following manners: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the processor is specially configured to obtain a data source of a corresponding type according to the parameter information through any one or more of following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the processor is specially configured to: obtain a file in a FTP server by means of a SFTP, and determine the file obtained as a data source of a FTP type.

As an optional implementation, the processor is specially configured to: receive a SQL statement executed by the user on a data source with which a connection is made, and determine the executed SQL statement as a data source of a SQL statement type.

As an optional implementation, the processor is specially configured to: establish a connection with each type of data source according to connection information of each type of data source.

As an optional implementation, the processor is specially configured to: write the connection information of each type of data source into a configuration file of a distributed query engine; and when starting the distributed query engine, establish, according to the connection information of each type of data source in the configuration file, the connection with each type of data source.

As an optional implementation, when the data source is a data source of a database type, the processor is specially configured to: establish a connection with the data source of the database type according to a database parameter, wherein the database parameter represents a parameter required to connect with a database.

As an optional implementation, when the data source is a data source of an interface type, the processor is specially configured to: run an interface according to an interface parameter to obtain JSON data, and parse the JSON data to obtain a data source parameter; and establish a connection with the data source of the interface type according to the data source parameter parsed and the interface parameter.

As an optional implementation, when the data source is a data source of text type, the processor is specially configured to: determine a data source parameter according to a data source stored in a file storage server; and establish a connection with the data source of the interface type according to a server parameter of the file storage server and the data source parameter.

As an optional implementation, the data source parameter includes at least one of a data source identifier, a type of data source, a library field, a table field, a column field, or a field type of a column field.

As an optional implementation, when the data source is a data source of a SQL statement type, the processor is specially configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation, after parsing the SQL statement to obtain table information in the SQL statement, the processor is specially configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the processor is specially configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the processor is specially configured to: establish a connection between the shared data source application and each type of data source according to connection information of each data source described in a metadata; and establish a connection between each type of data source connected with the shared data source application and each business system through the shared data source application.

As an optional implementation, the processor is specially configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation, after the establishing a connection between each business system and each type of data source through the shared data source application, the processor is specially configured to: receive an operation instruction sent by the business system in a form of a metadata through the shared data source application; and perform at least one operation of aggregation, filtering, or query on a data source corresponding to the operation instruction.

As an optional implementation, the processor is specially configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the processor is specially configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the processor is specially configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the processor is specially configured to: determine a chart type specified by the user and a target data column in the target dataset; use the target data column as chart data corresponding to the chart type, and use a chart component to draw a chart corresponding to the chart type; and display the drawn chart on the visual page.

In the fourth aspect, embodiments of the present disclosure provide a visual data analysis apparatus, including: a connection establishment unit configured to obtain multiple types of data sources, and establishing a connection with each type of data source, wherein the type of data source is used to represent a source from which data is obtained; a visual display unit configured to display, through a visual page, each piece of table information contained in each type of data source with which the connection is made; an associating data unit configured to, in response to an association operation of a user on multiple tables that are displayed, generate a target dataset according to an association relationship between the multiple tables indicated by the association operation; a chart display unit configured to display the target dataset on the visual page by means of a chart.

As an optional implementation, the connection establishment unit is specially configured to obtain multiple types of data sources through any one or more of following manners: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the connection establishment unit is specially configured to obtain data source of a corresponding type according to the parameter information through any one or more of the following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the connection establishment unit is specially configured to: obtain a file in a FTP server by means of a SFTP, and determine the file obtained as a data source of a FTP type.

As an optional implementation, the connection establishment unit is specially configured to: receive a SQL statement executed by the user on a data source with which a connection is made, and determine the executed SQL statement as a data source of a SQL statement type.

As an optional implementation, the connection establishment unit is specially configured to: establish a connection with each type of data source according to connection information of each type of data source.

As an optional implementation, the connection establishment unit is specially configured to: write the connection information of each type of data source into a configuration file of a distributed query engine; and when starting the distributed query engine, establish, according to the connection information of each type of data source in the configuration file, the connection with each type of data source.

As an optional implementation, when the data source is a data source of a database type, the connection establishment unit is specially configured to: establish a connection with the data source of the database type according to a database parameter, wherein the database parameter represents a parameter required to connect with a database.

As an optional implementation, when the data source is a data source of an interface type, the connection establishment unit is specially configured to: run an interface according to an interface parameter to obtain JSON data, and parse the JSON data to obtain a data source parameter; and establish a connection with the data source of the interface type according to the data source parameter parsed and the interface parameter.

As an optional implementation, when the data source is a data source of a text type, the connection establishment unit is specially configured to: determine a data source parameter according to a data source stored in a file storage server; and establish a connection with the data source of the interface type according to a server parameter of the file storage server and the data source parameter.

As an optional implementation, the data source parameter includes at least one of a data source identifier, a type of data source, a library field, a table field, a column field, or a field type of a column field.

As an optional implementation, in response to the data source being a data source of a SQL statement type, the connection establishment unit is specially configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation, after parsing the SQL statement to obtain table information in the SQL statement, the connection establishment unit is specially configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the connection establishment unit is specially configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the connection establishment unit is specially configured to: establish a connection between the shared data source application and each type of data source according to connection information of each data source described in a metadata; and establish a connection between each type of data source connected with the shared data source application and each business system through the shared data source application.

As an optional implementation, the connection establishment unit is specially configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation, after the establishing a connection between each business system and each type of data source through the shared data source application, the device further includes an operation unit configured to: receive an operation instruction sent by the business system in a form of a metadata through the shared data source application; and perform at least one operation of aggregation, filtering, or query on a data source corresponding to the operation instruction.

As an optional implementation, the associating data unit is specially configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the associating data unit is specially configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the associating data unit is specially configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the chart display unit is specially configured to: determine a chart type specified by the user and a target data column in the target dataset; use the target data column as chart data corresponding to the chart type, and use a chart component to draw a chart corresponding to the chart type; and display the drawn chart on the visual page.

In the fifth aspect, embodiments of the present disclosure further provide a computer storage medium on which a computer program is stored, wherein when the program is executed by a processor, steps of the method according to the above first aspect are implemented.

These aspects or other aspects of the present disclosure will be more clearly understood in the description of the following embodiments.

### BRIEF DESCRIPTION OF FIGURES

In order to more clearly illustrate the technical solutions in the embodiments of the present disclosure, a brief introduction will be given below to the drawings needed to be used in the description of the embodiments. Obviously, the drawings in the following description are only some embodiments of the present disclosure. Those of ordinary skill in the art can also obtain other drawings based on these drawings without exerting any creative effort.

FIG. 1 is an implementation flow chart of a visual data analysis method provided by an embodiment of the present disclosure.

FIG. 2A is a schematic diagram of an operation interface for dataset generation provided by an embodiment of the present disclosure.

FIG. 2B is a schematic diagram of an operation interface for dataset generation provided by an embodiment of the present disclosure.

FIG. 2C is a schematic diagram of an operation interface for filtering a dataset provided by an embodiment of the present disclosure.

FIG. 3A is a schematic diagram of an operation of a visual page for displaying a chart provided by an embodiment of the present disclosure.

FIG. 3B is a schematic diagram of an operation of a visual page for displaying a chart provided by an embodiment of the present disclosure.

FIG. 4A is a schematic diagram of an operation interface for obtaining a database provided by an embodiment of the present disclosure.

FIG. 4B is schematic diagram of an operation interface for obtaining a database provided by an embodiment of the present disclosure.

FIG. 5 is a schematic diagram of a connection operation interface for obtaining/creating Redis provided by an embodiment of the present disclosure.

FIG. 6 is a schematic diagram of an operation interface for obtaining a SQL data source provided by an embodiment of the present disclosure.

FIG. 7 is an implementation flow chart of a registration data source provided by an embodiment of the present disclosure.

FIG. 8A is a schematic diagram of an operation interface for connecting with an API data source provided by an embodiment of the present disclosure.

FIG. 8B is a schematic diagram of an operation interface for connecting with an API data source provided by an embodiment of the present disclosure.

FIG. 9 is a flow chart for establishing a connection with an API data source provided by an embodiment of the present disclosure.

FIG. 10 is a flow chart for connecting a SQL statement data source provided by an embodiment of the present disclosure.

FIG. 11 is a schematic diagram of an operation interface for configuring a SQL data source provided by an embodiment of the present disclosure.

FIG. 12 is a schematic diagram of a SQL parsing syntax tree provided by an embodiment of the present disclosure.

FIG. 13 is a schematic diagram of a traditional business system-data source connection relationship provided by an embodiment of the present disclosure.

FIG. 14 is a schematic architectural diagram of a connection between each business system and each data source provided by an embodiment of the present disclosure.

FIG. 15 is an implementation flow chart of a shared data source provided by an embodiment of the present disclosure.

FIG. 16 is a schematic diagram of a visual data analysis system provided by an embodiment of the present disclosure.

FIG. 17 is a schematic diagram of a visual data analysis device provided by an embodiment of the present disclosure.

FIG. 18 is a schematic diagram of a visual data analysis apparatus provided by an embodiment of the present disclosure.

### DETAILED DESCRIPTION

In order to make the purpose, technical solutions and advantages of the present disclosure clearer, the present disclosure will be described in further detail below in conjunction with the accompanying drawings. Obviously, the described embodiments are only some, but not all, of the embodiments of the present disclosure. Based on the embodiments in the present disclosure, all other embodiments obtained by those of ordinary skill in the art without making creative efforts fall within the claimed scope of the present disclosure.

In the embodiments of the present disclosure, the term “and/or” describes the association relationship of associated objects, indicating that there can be three relationships, e.g., A and/or B, which can mean: A exists alone, A and B exist simultaneously, and B exists alone. The character “/” generally indicates that the related objects are in an “or” relationship.

The term “data source” in the embodiments of the present disclosure describes the source of data, and represents a device or original media that provides certain required data.

The term “dataset” in the embodiments of the present disclosure is also called a data set, an aggregate of data or a collection of data, and represents a collection composed of data. A dataset is a collection of data, and is usually in tabular form. Each column represents a specific variable. Each row corresponds to a dataset for a certain user.

The term “database” in the embodiments of the present disclosure describes “a warehouse that organizes, stores and manages data according to a data structure”, and represents a collection of large amounts of data that is stored in a computer for a long time and is organized, shareable, and uniformly managed.

The term “Redis”, i.e., a remote dictionary service, in the embodiments of the present disclosure represents an open source log-type Key-Value database which is written in the ANS C language, supports the network, and is memory-based and persistent, and this database provides API of multiple languages, and often used for caching under high concurrency.

The term “Kafka” in the embodiments of the present disclosure represents a high-throughput distributed publish-subscribe messaging system that can process all action flow data of consumers in the website. Such actions (e.g., web browsing, searching and other actions of the user) are a key factor in many social functions on the modern web. This data is typically addressed by processing logs and log aggregation due to the throughput requirement. This is a feasible solution for log data and offline analysis systems like but requiring real-time processing constraints the Hadoop. The purpose of Kafka is to unify online and offline message processing through Hadoop's parallel loading mechanism, and to provide real-time messages through the cluster.

The term “API” in the embodiments of the present disclosure refers to an application programming interface (API) also known as an application program interface, which is an agreement for connecting different components of a software system and used to provide applications for developers with the ability to access a set of routines without having to access the source code or understanding the details of the inner workings.

The term “SFTP” in the embodiments of the present disclosure means that in the computer field, SSH file transfer protocol (also known as secret file transfer protocol, Secure FTP or SFTP) is a data stream connection that provides a Network transfer protocol for file access, transfer and management functions.

The term “Presto” in the embodiments of the present disclosure is a Facebook open source distributed SQL query engine and is suitable for interactive analysis queries, and the data volume supports GB to PB bytes. The architecture of Presto evolved from the architecture of relational database.

The term “SQL” in the embodiments of the present disclosure refers to a structured query language (SQL) for short, which is a special-purpose programming language and a database query and programming language used for accessing data and querying, updating and managing relational database systems.

The term “CSV” in the embodiment of the present disclosure means the comma-separated value, which is a universal and relatively simple file format, and is able to transfer table data between programs.

The term “Minio” in the embodiments of the present disclosure is an object storage service based on an open source protocol of the Apache License v2.0. It is compatible with the Amazon S3 cloud storage service interface and is very suitable for storing unstructured data of large capacity, such as pictures, videos, log files, backup data and container/virtual machine images, etc., and an object file can be of any size, ranging from several kb to the maximum of 5 T.

The scenarios described in the embodiments of the present disclosure are to more clearly illustrate the technical solutions of the embodiments of the present disclosure, and do not constitute a limitation on the technical solutions provided by the embodiments of the present disclosure. Those of ordinary skill in the art will know that with the emergence of new application scenarios appears that the technical solutions provided by the embodiments of the present disclosure are equally applicable to similar technical problems. In the description of the present disclosure, unless otherwise specified, “plurality/multiple” means two or more.

For example, in recent years, various companies have been building visual data analysis systems. Most of the current visualization platforms are implemented for a specific data source. The development of big data has brought about the diversification of data. The source of data is not only obtained from the database, but also from external open interfaces and temporary cache data during the operation of some products, etc. These data can be solidified in certain ways into the database for visual display through the database visualization system. However, the mode of obtaining data from an open interface or from a temporary cache and solidifying it into a database will not only occupy the storage resources of the visualization system itself, but is also not conducive to the analysis of massive data on the cloud platform.

Currently, some companies share a user system. Since a user system includes multiple business platforms, each user will leave a large amount of user data on each business platform. In order to accurately push related products in the future, a summary analysis for user behaviors on different business platforms is required. Each business platform involves a large amount of table data, such as the table data in Presto. When performing the business query analysis, although a SQL statement can be used to combine the data in each business system, each time a connection with a table is added, the complexity of the connection will increase exponentially, which will undoubtedly bring challenges to the performance of the query engine. Moreover, users of each business platform do not understand the business of other platforms, and are required a lot of business sorting work before performing SQL correlation.

In the data analysis method provided by the present disclosure, multiple types of data sources can be accessed, and the combined analysis for various data sources can be realized through the simple combination and association operations and is displayed on the visual page through a chart. Not only is the operation simple, but due to the establishment of connection relationship with various types of data sources, there is no need to store the data sources in a solidified mode. Not only data query and analysis can be performed in real time, but also storage resources can be saved. The core idea of the data analysis method of the present disclosure is that after establishing connections with various types of data sources, various types of data sources are displayed through the visual page, and the target dataset is generated through the associated operation of the user on the multiple tables displayed on the visual interface, and is visually displayed. During the entire operation process, the user only needs simple correlation operations to achieve combined analysis for different types of data sources and perform visual display.

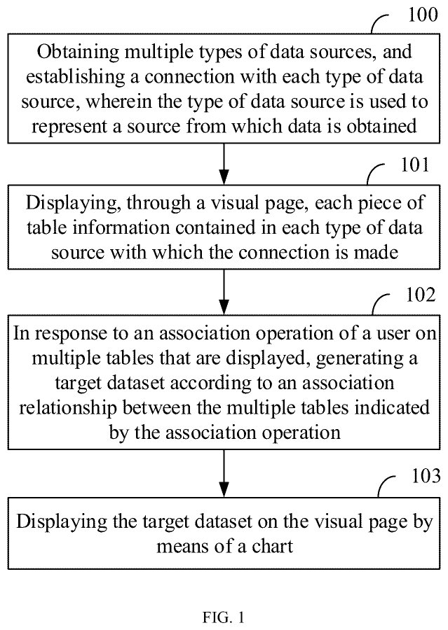

As shown in FIG. 1, the specific implementation process of a visual data analysis method provided by the embodiment is as follows.

Step 100: obtaining multiple types of data sources, and establishing a connection with each type of data source, wherein the type of data source is used to represent a source from which data is obtained.

During the implementation, in the embodiment, connections with various types of data sources can be established, and various types of data sources can be accessed in real time by establishing connection relationships. Optionally, in the embodiment, multiple types of data sources can be obtained in any one or more of the following manners.

Manner (1): receiving parameter information input by the user, and obtaining a data source of a corresponding type according to the parameter information.

In some embodiments, the parameter information in the embodiment includes but is not limited to one or more of a database parameter, an interface parameter, text data, a Redis parameter, or a SQL statement.

In some embodiments, obtaining a data source of a corresponding type according to the parameter information through any one or more of following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

During the implementation, in the embodiment, parameter information of multiple types of data sources input by the user can be received, and the corresponding type of data source is obtained according to the multiple pieces of parameter information. For example, receiving a database parameter input by the user, and obtaining a data source of a database type according to the database parameter; receiving an interface parameter input by the user, and obtaining a data source of an interface type according to the interface parameter; and receiving a SQL statement input by the user, and determining the SQL statement input as a data source of a SQL statement type. In the above-mentioned manners of obtaining the data source of the corresponding type according to the parameter information, one or a combination of the manners may be selected, which will not be overly limited in the embodiment.

Manner (2): obtaining a data source of a corresponding type through a file transfer protocol.

In some embodiments, the file in the FTP server is obtained by means of the SFTP, and the obtained file is determined as the data source of the FTP type.

Manner (3): using an executed structured query language (SQL) statement as an obtained data source of a corresponding type.

In some embodiments, a SQL statement executed by the user on a connected data source is received, and the executed SQL statement is determined to be the data source of the SQL statement type.

During the implementation, in the embodiment the above manners (1), (2) and (3) can be combined, and multiple types of data sources can be obtained through the combined manners. The embodiment does not make too many specific limited on combination manners.

In some embodiments, the data sources in the embodiment include but are not limited to any of the following.

Type 1: a data source of a database type includes but is not limited to at least one of: Mysql (relational database management system), PostgreSql (a free object-relational database server (database management system)), Oracle (a large database software), DAMENG (database), Hive (a data warehouse analysis system built based on Hadoop, which provides a rich set of SQL query manners to analyze data stored in the Hadoop distributed file system), Hbase (a distributed column-oriented open source database), or InfluxDB (an open source timing sequence database developed using the GO language, which is especially suitable for processing and analyzing timing sequence related data such as resource monitoring data).

Type 2: a data source of an interface type includes but is not limited to an API interface. Optionally, the API protocol provided includes but is not limited to at least one of: a HTTP protocol, a RPC (remote procedure call) protocol, a socket protocol or a SDK (software development kit) protocol.

Type 3: a data source of a text type includes but is not limited to at least one of: an Excel text, a CSV text, or a TXT text.

Type 4: a data source of a FTP type includes but is not limited to at least one of: a SFTP type or a FTP type.

Type 5: a data source of a Redis cache type includes but is not limited to at least one of: a Redis cache or other caches.

Type 6: a data source of a SQL statement type includes but is not limited to at least one of: a SQL statement input by a user, an executed SQL statement, a stored SQL statement, or a generated SQL statement.

Type 7: data sources of other types include but are not limited to at least one of: a local file, an ES (file browser), kafka (a high-throughput distributed publish-subscribe messaging system, which can handle all action stream data of consumers in the website) or clickhost.

Optionally, in the embodiment, the Presto component is used to obtain and connect each type of data source.

Step 101, displaying, through a visual page, each piece of table information contained in each type of data source with which the connection is made.

In some embodiments, in the embodiment, the visual page is configured by embedding the URL into the web or terminal, etc., without the need for joint debugging of the web end and the backend defined interface(s), etc., so that the visual display does not rely heavily on the frontend and backend development.

In some embodiments, the table information in the embodiment includes but is not limited to at least one of: a data source identifier to which a table belongs, a table field name, a column field name, or a field type of a column field.

In the implementation, each type of data source includes one or more pieces of table information. Taking a database as an example, the database includes at least one library, and each library includes at least one table. The column information in each table of each library of the database can be determined as the table information.

In the embodiment, column information in each table contained in each type of data source can be displayed. For example, each column field name in each data source is displayed on the right side of the visual page.

Step 102, in response to an association operation of a user on multiple tables that are displayed, generating a target dataset according to an association relationship between the multiple tables indicated by the association operation.

During the implementation, since the table information in each type of data source has been displayed on the visual page, the user can establish the association between two or more tables through the simple association operation, and finally, by executing the SQL statement, the target dataset is generated according to the relationship between multiple tables.

In some embodiments, the association operation in the embodiment includes but is not limited to at least one of: a dragging operation, a click operation, or an operation of inputting association information, which will not be overly limited in the embodiment. During the implementation, the user can drag the displayed multiple pieces of table information that needs to be associated to the specified area through a simple dragging operation. When the dragging operation is performed, the backend interface is called to obtain all the information, which includes information such as the data source to which belongs, each column field, etc., of the table corresponding to the table information, and then multiple tables are associated in the specified area to generate the target dataset.

In some embodiments, the target dataset is generated in the following manner: in response to a dragging instruction of the user for the multiple tables displayed, determining table information of each target table corresponding to the dragging instruction; and receiving an association relationship between multiple target tables input by the user, and generating a target dataset according to the table information of each target table and the association relationship.

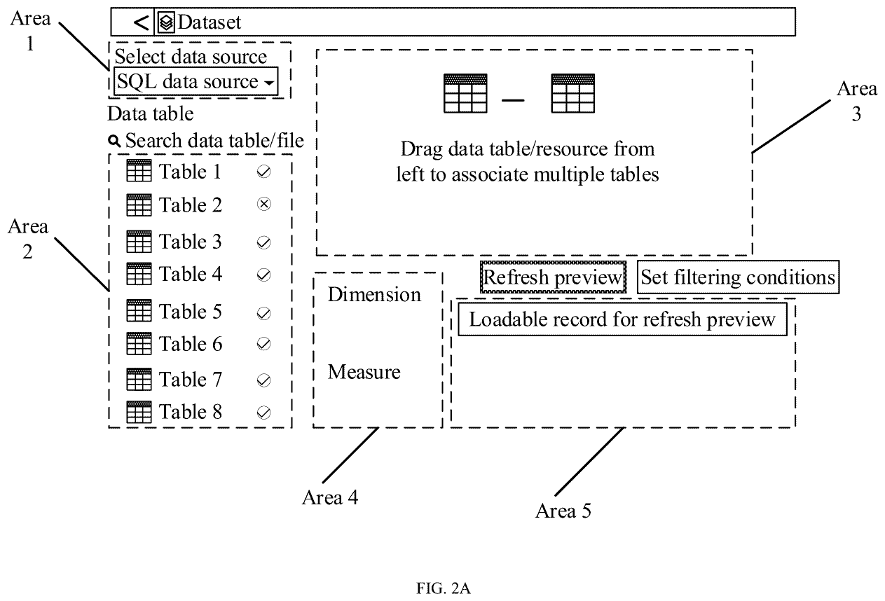

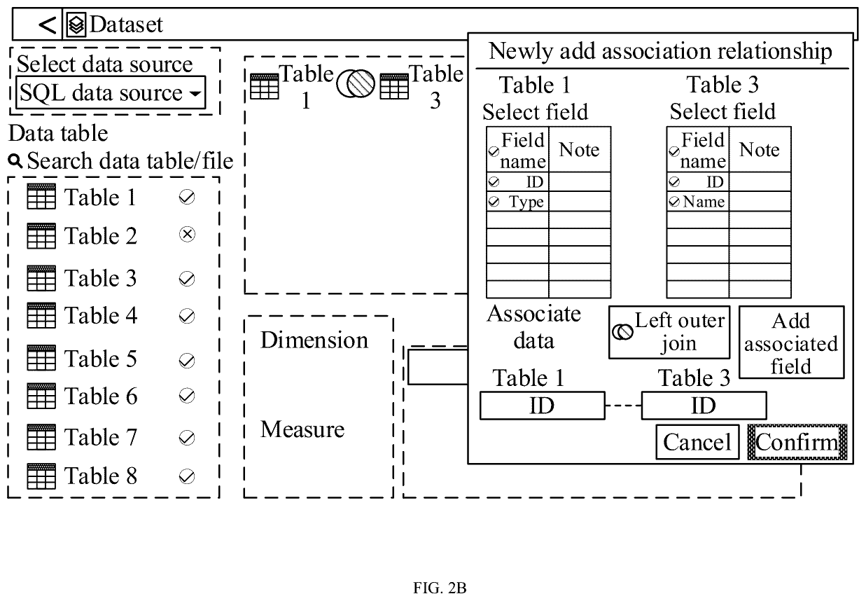

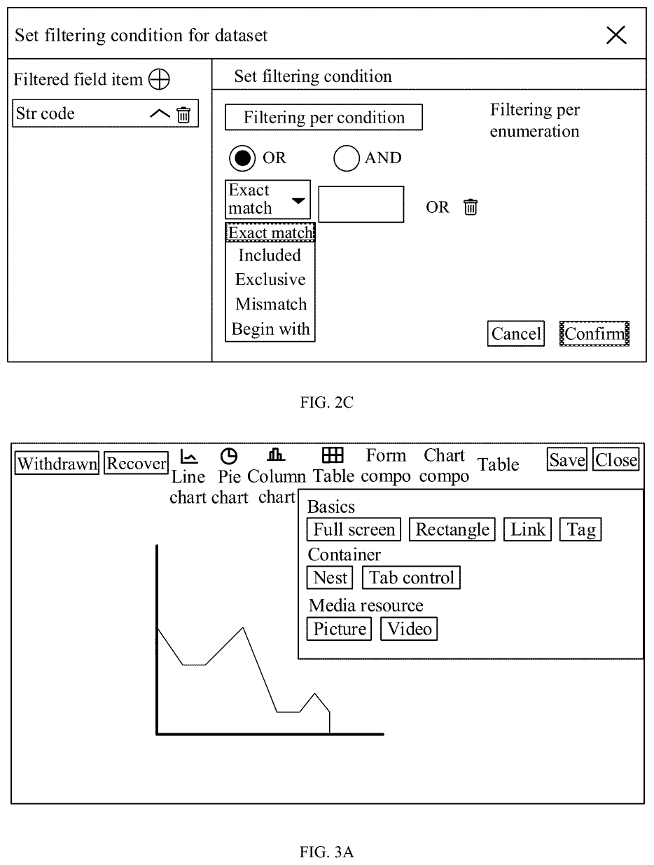

Optionally, in the embodiment, data information in various data sources can be aggregated through a simple dragging manner. During the implementation, as shown in FIGS. 2A-2B, the embodiment provides a schematic diagram of an operation interface for dataset generation. As shown in FIG. 2A, the user can select any data source with which a connection has been established (corresponding to the area 1 in the figure). After selecting the data source, all table information under the data source is displayed (corresponding to the area 2 in the figure). The user selects multiple target tables and drags the table information of multiple target tables to the specified area (corresponding to the area 3 in the figure). When dragging the table information, the backend invokes the backend interface to obtain all information, which includes a data source, all column fields, etc., of the target table, and then the user can specify the relationship between multiple target tables, that is, certain column fields in the multiple target tables are consistent, thereby associating multiple target tables together. The area 4 in the figure is an attribute area. Each attribute in the generated target dataset can be renamed, copied, deleted and etc. The attribute refers to table attribute information such as a table field and a column field, etc. The area 5 in the figure is a preview area, which intuitively display whether the target dataset after data aggregation meets the expectation to the user. As shown in FIG. 2B, the user can input the association relationship between multiple target tables, that is, define certain column fields in multiple target tables to be the same, thereby determining the association relationship between multiple target tables and generating the target dataset.

In some embodiments, generating a target dataset according to the table information of each target table and the association relationship in the following manner: determining first fields, that are the same, between the multiple target tables and second fields that are retained after the multiple target tables are associated according to the association relationship; and generating a SQL statement according to the table information of each target table, the first fields and the second fields, and executing the SQL statement to obtain the target dataset.

In some embodiments, a filtering condition input by the user also can be received. The filtering condition is used to filter data in multiple target tables. According to the filtering condition, target dataset, table information of the multiple target tables, and the association relationship between the multiple target tables are generated.

In the implementation, the dataset can be generated by simply dragging to combine “tables” in multiple data sources. The corresponding connection can be a left outer join and an inner join in SQL. The association between the two tables requires a bridge, so when the two tables are associated, the same attributes (such as the same column fields) need to be specified. In addition to the association, the filtering condition can also be added on the basis of the association. As shown in FIG. 2C, the embodiment provides an operation interface for filtering datasets. For example, there is a table that includes information related to the product(s) purchased by the user, and now user purchase information for the clothing category needs to be created, then there is a need to add a filtering condition to match the product type as clothes.

The following explains the data association and filtering process in the embodiment through specific examples.

For example, a table A is a product table, a table B is a user table, and a table C is a user purchase product record table. The association relationship between the tables is that the table A links the table B and the table C. The association relationship specifically includes that the product ID of the table A is identical to the product ID of the table C, and the user ID of the table B is identical to the user ID of the table C. The filtering condition is that the product type in the table B is clothes. During the implementation, the frontend can send the data source ID (which can be obtained by invoking the backend interface when the user drags, various kinds of subsequent required information of the data source also being obtained) of each of the table A, the table B and the table C, the retained fields after the tables are associated, and the fields being identical when the tables are associated to the backend. The backend generates the SQL statement in the following format, and then invokes Presto to obtain the SQL result and displays it on the interface. The format is as below:
SELECT Table A retaining an attribute, Table B retaining an attribute, and Table C retaining an attribute
FROM A (left) join B (left) join C on A.id=C.produc_id and B.id=C.user_id
WHERE A.product_type=‘clothes’.

Optionally, the attribute in the embodiment refer to relevant information such as a data source ID and its type, a table field and its type, each column field in the table and its type, etc.

In some embodiments, the generated target dataset can be added to the execution body as a new data source for the subsequent use. Optionally, the target dataset can be stored in a business database for the subsequent use.

Step 103, displaying the target dataset on the visual page by means of a chart.

In some embodiments, the chart is drawn and displayed in the following manner: determining a chart type specified by the user and a target data column in the target dataset; using the target data column as chart data corresponding to the chart type, and using a chart component to draw a chart corresponding to the chart type; and displaying the drawn chart on the visual page.

During the implementation, in the embodiment, the type of chart that needs to be drawn is first specified, then the target data columns in the target dataset that needs to be drawn is dragged to the designated area by the dragging manner, and the chart component is used to draw the chart and display the drawn chart visually.

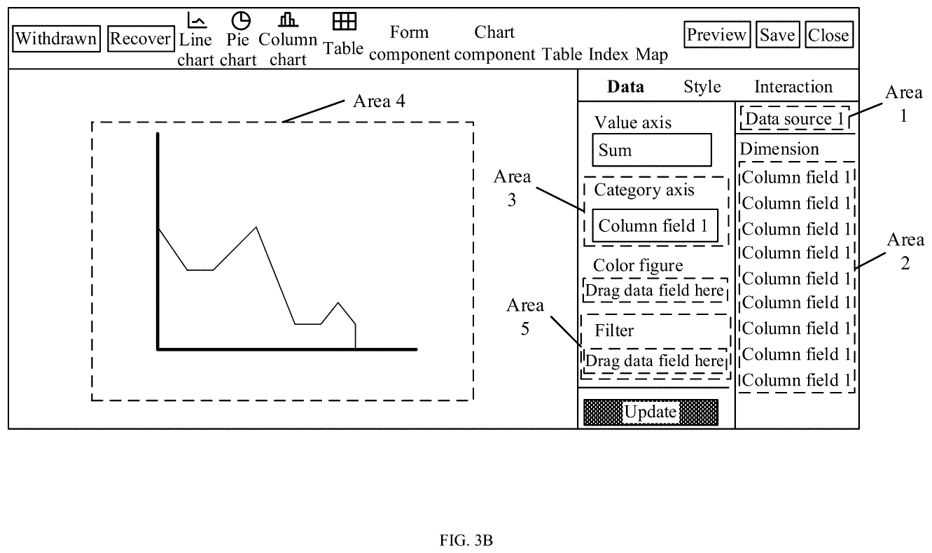

In some embodiments, the chart component includes but is not limited to the frontend open source component Echart. The user selects a chart type by clicking to generate a chart, and then configures chart data for the selected chart. As shown in FIGS. 3A-3B, the embodiment provides a schematic diagram of an operation of a visual page for displaying a chart. After the user selects the line chart, the user can set the line chart, such as changing the style, inserting multimedia data, entering text and other editing operations. After the setting is completed, as shown in FIG. 3B, selecting the target dataset to be displayed from the table information of the data sources displayed in the right column of the page (corresponding to area 1 marked in the figure). After the target dataset is selected, all data columns in the target dataset is listed (corresponding to the area 2 marked in the figure). The user selects the target data column from all data columns, uses the target data column as the chart data corresponding to the chart type, and drags the target the data column to a specified area (corresponding to the area 3 marked in the figure), and uses the chart component to draw and display a line chart generated based on the target data column (corresponding to the area 4 marked in the figure).

In some embodiments, after determining the user-specified chart type and the target data column in the target dataset, the method further includes: receiving a filtering condition input by the user (corresponding to area 5 marked in FIG. 3B), where the filtering condition is used to filter the data in the target data column; using the filtered target data column as chart data corresponding to the chart type, and using the chart component to draw a chart corresponding to the chart type; and displaying the drawn chart on the visual page.

Optionally, the user can also edit the color, text format, background, etc. of the displayed chart, which will not be overly limited in the embodiment.

It should be noted that in the embodiment, establishing connections with various types of data sources mainly includes two aspects. On the one hand, it focuses on establishing connection relationships, and on the other hand, it focuses on sharing connection relationships. The establishment of connection relationships mainly includes the process of obtaining and registering data sources (i.e., connections). The sharing of connection relationships mainly includes providing a connection relationship for shared data sources from the overall architecture of the business system and the database connection.

The first aspect is the establishment of the connection relationship(s).

In some embodiments, multiple types of data sources are obtained in any of the following manners.

Manner 1), receiving a database parameter input by the user, and obtaining a data source of a database type according to the database parameter.

In some embodiments, the database parameter in the embodiment includes but is not limited to at least one of: an IP address, a port number, a database name, a database type, a login user name, a login password, or a data source name, etc.

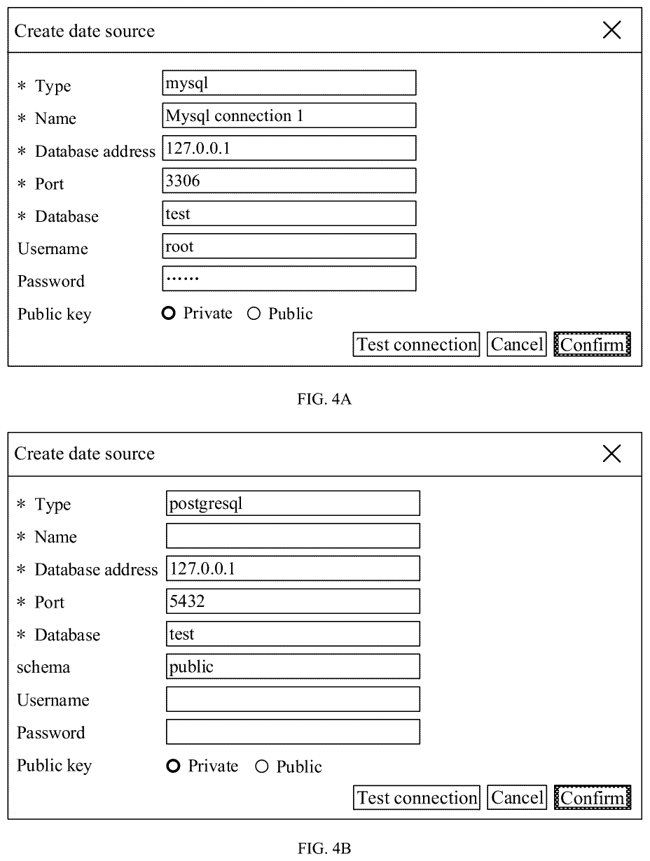

Optionally, in the embodiment, the Presto component is used to obtain and connect each type of data source. The Presto has internally integrated connectors for some databases, such as Mysql, PostgreSql, Oracle and other databases. Different database parameters can be entered for different databases. For details, please refer to the official Presto documentation. For unsupported database types, the plug-in development can be carried out based on the Presto source code. For example, the connection function can be developed for the DAMENG database. When the user chooses to directly connect with a database (the database corresponding to the internally integrated connector), the type of database need to be specified. There are also differences in the database parameters filled in for different database types. Take Mysql and PostgreSql as examples, the FIGS. 4A-4B show a schematic diagram of an operation interface for obtaining a database provided in the embodiment. The content corresponding to “*” represents the database parameter that the user needs to input. After the user enters the database parameter, the backend service can use the Presto to connect with the corresponding database to verify whether the entered database parameter is correct. If it is wrong, it will be fed back to the user. If it is correct, it will prompt the user to save the database parameter information entered by the user in the local database.

Manner 2), receiving an interface parameter input by the user, and obtaining a data source of an interface type according to the interface parameter.

In some embodiments, the interface parameters in the embodiment include but are not limited to at least one of: an interface name, an interface invoking mode, or an interface path. The interface path includes an interface IP address and a port.

Manner 3), obtaining text data uploaded by the user, and determining text data named by the user as a data source of a text type.

In some embodiments, the text data in the embodiment includes but is not limited to at least one of: an Excel text, a CSV text, or a TXT text.

In the actual development process, some open source datasets will inevitably be used. When the format of the open source dataset is an Excel/CSV format, it can support the user to upload historically saved data in the form of the Excel/CSV/TXT text in the embodiment, and the user only needs to name the data source. When using the Presto component to obtain and connect each type of data source, since the Presto can recognize data in the CSV format, the text data uploaded by the user can be converted into the CSV format and is stored in the local storage in the text form for the subsequent use. Since the text data is stored in the text form, the storage space is not taken up more.

Manner 4), obtaining a file in a FTP server by means of a SFTP, and determining the file obtained as a data source of a FTP type.

During the implementation, in view of the early enterprises, a lot of data is stored on the FTP server. In order to provide better services, it can also support the user to obtain a file from the FTP server through SFTP and register it in the execution body in the embodiment. The supported file formats are Excel, CSV, and TXT formats. The execution body in the embodiment may be one of a platform, a system, and a device, which will not be overly limited in the embodiment.

Manner 5), receiving a Redis parameter input by the user, and obtaining a data source of a Redis cache type according to the Redis parameter.

The embodiment also supports Redis cache as a data source. In certain environments, such as the Double 11 e-commerce promotion, the server will receive a large amount of order information in a short period of time. If the order information is directly stored in the database, high frequency writing operations are very likely to bring down the database and cause service abnormalities. In this case, the order information is usually stored in the cache first, and then synchronized to the database within a period of time. If it needs to analyze the current sales situation in a timely manner, it is necessary to obtain the data in the cache. The embodiment provides a method for analyzing the current purchase information in real time, which obtains the data source(s) in the Redis cache and analyzes it in real time to recommend more suitable products for the user.

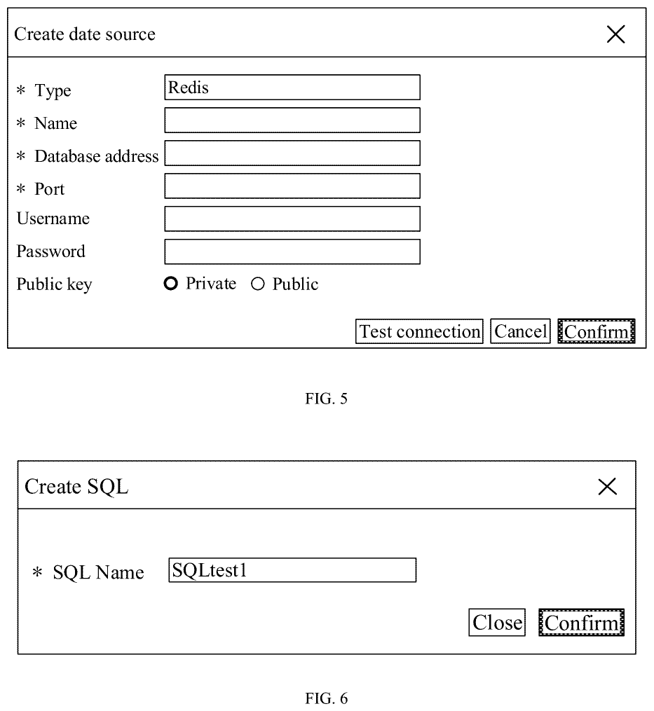

It should be noted that in the embodiment, after obtaining the data sources of the Redis cache type, it is considered that a connection relationship with the data source of the Redis cache type is established. As shown in FIG. 5, the embodiment provides a connection operation interface for obtaining/creating Redis. The user need to provide a data source type, a Redis cache type, s data source name, a Redis cache name, a data source address, a Redis cache address, a data source port number, a Redis cache port number, a user login name, a login password, etc.

Manner 6), receiving a SQL statement input by the user, and determining the SQL statement input as a data source of a SQL statement type; or, receiving a SQL statement executed by the user on a data source with which a connection is made, and determining the executed SQL statement as a data source of a SQL statement type.

As shown in FIG. 6, the embodiment provides an operation interface for obtaining a SQL data source, in which the user only needs to enter the name of a customized SQL statement.

During the implementation, in the embodiment, for the data sources with which the connections have been already established (already registered), the data sources can be connected by running the SQL statement(s), and the SQL statement, which is reused as the table registration information in a data source in an intermediate process, is registered back into the Presto, thereby allowing the data source to be reused. When creating a SQL data source, it only needs to enter the data source type as the SQL type and enter the data source name.

For example, in order to obtain the basic information of users who purchased windbreakers on the first platform and the second platform, at least three tables are needed in a short. One is the user information table marked as a table A, one is the user purchase record table in the first platform marked as a table B, and one is the user purchase record table in the second platform marked as a table C. Assuming that the product IDs of the windbreakers in different platform are the same, obtaining the basic information of the users who purchased the windbreakers on the first platform and the second platform can be divided into three steps. Step 1: first retrieving user IDs of users who purchased windbreakers from the table C. Step 2: querying users who purchased windbreakers from table A and the user IDs of whom are in a retrieved result of step 1. Step 3: associating a result of step 2 with the user information table to obtain the basic information of users who purchased windbreakers on both the first platform and the second platform. For step 2, it can reuse the SQL statement(s) executed in step 1, and it only needs to add some filtering conditions that are different from step 1. For step 3, it also can reuse the SQL statement in step 2 with adding relevant filtering conditions. In the embodiment, since the SQL statement(s) is used as a data source, when executing complex data combination query, the nested SQL statement can be generated and used as the data source, without need to use a result of the SQL statement executed every time as a data source to continue to increase the number of table connections, causing the complexity of multi-table associations to increase exponentially. Based on this method, the embodiment can be applied to any complex SQL statement and simplify the complex SQL statement. By generating the nested SQL statement and directly executing the final nested SQL statement, the resource occupied when querying complex data combination is reduced, so that the result set of SQL execution does not need to be stored in the physical space, but the SQL statement itself is reused as a data source, effectively improving the query efficiency.

In some embodiments, establishing a connection with each type of data source in the following manners: establishing a connection with each type of data source according to connection information of each type of data source.

In some embodiments, the connection information includes but is not limited to: at least one of: a database parameter, an interface parameter, a data source parameter, a server parameter, a SQL statement, or table information in the SQL statement. Specifically, the connection information is defined according to the type of data source, which will not be overly limited in the embodiment.

In some embodiments, establishing a connection with each type of data source in the following manner according to the connection information of each type of data source: writing the connection information of each type of data source into a configuration file of a distributed query engine; and when starting the distributed query engine, establishing, according to the connection information of each type of data source in the configuration file, the connection with each type of data source.

In the embodiment, taking Presto as an example, by utilizing the characteristics of the Presto distributed query engine, multiple data sources can be associated. There are three concepts in the Presto engine: the catalog, schema, and table. The catalog can be understood as the data source, the schema can be understood as the mode, which corresponds to a specific database in databases, and the table corresponds to the table information in a database. The Presto has built-in connectors for multiple data sources, such as Mysql, PostgreSql, Hive, Kafka, Redis, etc.

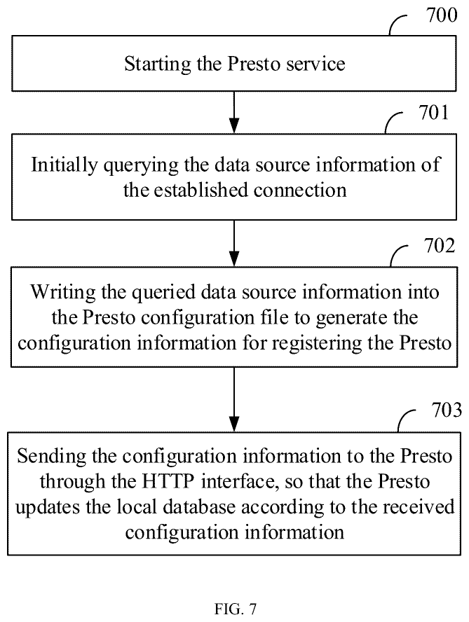

For the data source type of the built-in connector in the Presto, it only needs to write the data source connection information (such as the database parameter of the database such as the URL, user name, password, etc.) into the Presto configuration file. As shown in FIG. 7, the embodiment further provides an implementation process for registering a data source. The specific registration process (i.e., the connection establishment process) is as follows. Step 700: starting the Presto service. Step 701: initially querying the data source information of the established connection. Step 702: writing the queried data source information into the Presto configuration file to generate the configuration information for registering the Presto. Step 703: sending the configuration information to the Presto through the HTTP interface, so that the Presto updates the local database according to the received configuration information.

During the implementation, when the Presto service is started, the data source connection information obtained in the embodiment is modified to the Catalog of the Presto through the HTTP interface, thereby registering the data source information in the Presto.

During the use, if the data source needs to be edited, it can delete the data source through the http interface and then registers a data source again. The data source name in the Presto is unique. In order to facilitate management and maintenance, the embodiment also creates a data source ID for each data source, and uses the created data source ID as the name of the connected data source in the Presto.

In some embodiments, corresponding connection information is provided according to different types of data sources, and a connection relationship with the data source is established through any of the following cases.

Case 1, the data source is a data source of an database type.

Optionally, establishing a connection with the data source of the database type according to a database parameter, wherein the database parameter represents a parameter required to connect with a database.

In some embodiments, the connection information includes database parameters. The database parameter in the embodiment includes but is not limited to at least one or more of a IP address, a port number, a database name, a database type, a user login name, a login password, or a data source name, etc.

Case 2: The data source is a data source of interface type.

Optionally, running an interface according to an interface parameter to obtain Java script object notation (JSON) data, and parsing the JSON data to obtain a data source parameter; and establishing a connection with the data source of the interface type according to the data source parameter parsed and the interface parameter.

In some embodiments, the connection information includes a data source parameter and an interface parameter. Optionally, the interface parameter includes but is not limited to a user-defined interface name, an interface invoking mode, a IP address, a port, an interface path and other interface information.

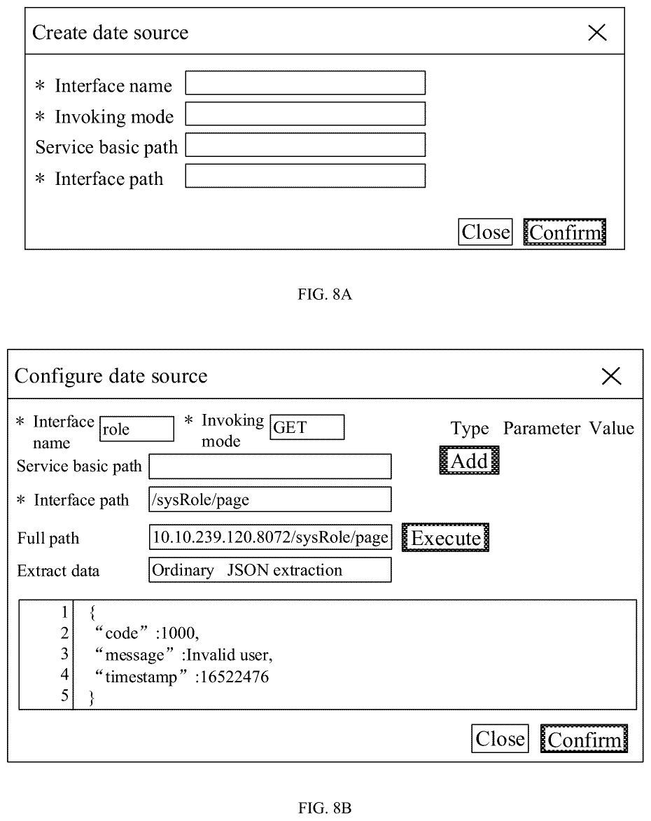

In the implementation, taking the data source of API interface type as an example, FIGS. 8A-8B are schematic diagrams of an operation interface for connecting with the API data source. In FIG. 8A, when the user creates the API data source, the user enters the interface parameter in the interface. The interface parameter includes an interface name, an interface invoking mode, an IP, a port, an interface path (such as universal resource locator), etc., to obtain the API data source. After obtaining the API data source, as shown in FIG. 8B, the API interface is run to obtain JSON (JavaScript object notation, a lightweight data exchange format) data, and the JSON data is parsed to obtain the data source parameter.

The parsed data source parameter includes but is not limited to at least one of: a data source identifier, a type of data source, a library field, a table field, a column field, or a field type of a column field. According to the parsed data source parameter and the interface parameter, a connection is established with the data source of the interface type.

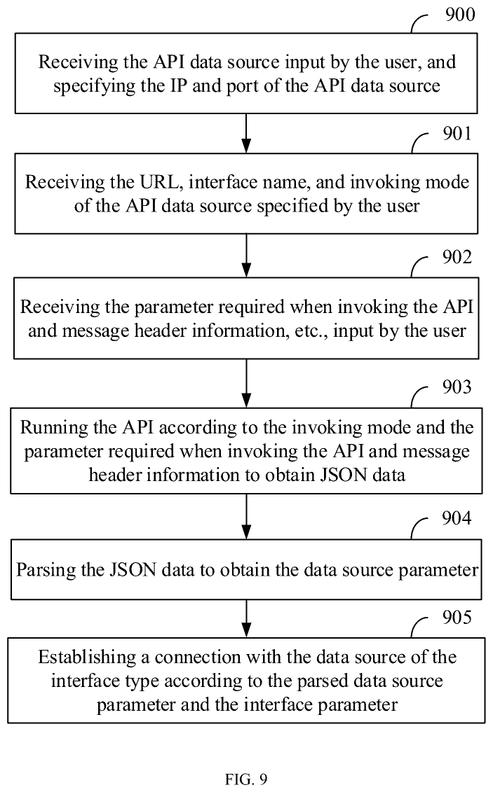

As shown in FIG. 9, taking the data source with which a connection is established as a data source of an interface type as an example, the embodiment provides a flow for establishing a connection with an API data source to illustrate when the data source is a data source of an interface type, how to obtain the data source and establish a connection with the data source based on the connection information of the data source. The implementation steps of this flow are as follows.

Step 900: receiving the API data source input by the user, and specifying the IP and port of the API data source.

Step 901: receiving the URL, interface name, and invoking mode of the API data source specified by the user.

Step 902: receiving the parameter required when invoking the API and message header information, etc., input by the user.

During the implementation, in the embodiment, the interface parameter(s) input by the user is received, and the data source of the interface type is obtained according to the interface parameter, where the interface parameter includes API interface parameter. Optionally, the API interface parameter in the embodiment includes but is not limited to at least one of: an IP address, a port, a URL of an API data source, an interface name, an invoking mode, a parameter required when invoking the API, or message header information.

Step 903: running the API according to the invoking mode and the parameter required when invoking the API and message header information to obtain JSON data.

Step 904: parsing the JSON data to obtain the data source parameter.

The data source parameter includes at least one of: a data source identifier, a type of data source, a library field, a table field, a column field, or a field type of a column field.

Step 905: establishing a connection with the data source of the interface type according to the parsed data source parameter and the interface parameter.

During the implementation, in the embodiment, an interface is run according to an interface parameter to obtain Java script object notation (JSON) data, and the JSON data is parsed to obtain a data source parameter; and a connection with the data source of the interface type is established according to the data source parameter parsed and the interface parameter. The interface parameter includes an API interface parameter.

In the implementation, JavaScript is used to read the JSON data returned by the interface as an object, then parse the corresponding data source parameter according to the data name entered by the user, and store the process of requesting to parse the data in the local database. The method of updating the data source is to delete the data source in the Presto and then re-register the data source. When registering a data source, taking the API data source as an example, it needs to provide the Presto with information in a preset format. The information provides the data source parameter and the interface parameter to the Presto in the preset format, thereby establishing the connection between the Presto and the API data source.

In some embodiments, the preset format in the embodiment is as follows.

```
{
  “schema”:[{
    “name”:“table1”,
    “columns”:[
      {
      “name”:“key1”,
      “type”:“bigint”
      },
      {
      “name”:“key2”,
      “type”:“varchar”
      }
    ],
    “sources”:[
      http://localhost:9080/data.csv;
    ]
  }
  ]
}
```

The “sources” in the above format is used to represent the source of data. When the data source is a database, the “sources” is the database source, such as a database name, an IP address, a port number and other information. When the data source is an interface data source, the “sources” refers to the interface source, such as an interface name, an IP address, a port number and other information. The same applies to other types of data sources, that is, the “sources” corresponds to the source of data and is used to fill in the source information of each type of data source.

During the implementation, the connection information of the data source is written into the configuration file of the distributed query engine according to the above preset format, so that when the distributed query engine is started, the connections with various types of data sources are established, respectively, according to the connection information of each type of data source in the configuration file.

Case 3, the data source is a data source of a text type.

Optionally, determining a data source parameter according to a data source stored in a file storage server; and establishing a connection with the data source of the interface type according to a server parameter of the file storage server and the data source parameter.

Optionally, the server parameter in the embodiment includes but is not limited to a server IP address, a port number, etc. The data source parameter in the embodiment includes at least one of: a data source identifier, a type of data source, a library field, a table field, a column field, or a field type of a column field.

During the implementation, in the embodiment, if the user creates a data source with data in the Excel/CSV/TXT format, the data in the above file is not written into the local database, but the file is uploaded to the Minio server, and an interface for querying file content is provided and placed in the source field by a manner of adding the data source through the Http. For details, referring to the above preset format, and the server parameter can be added to the source field in the above preset format to register the data source to the Presto.

Optionally, for a data source of a FTP type, the file can be registered from the network to the Presto through the SFTP.

Case 4. The data source is a data source of a SQL statement type.

Optionally, performing a syntax verification on a SQL statement, and after determining that the syntax verification passes, parsing the SQL statement to obtain table information in the SQL statement; and establishing a connection with the data source of the SQL statement type according to the SQL statement and the table information in the SQL statement.

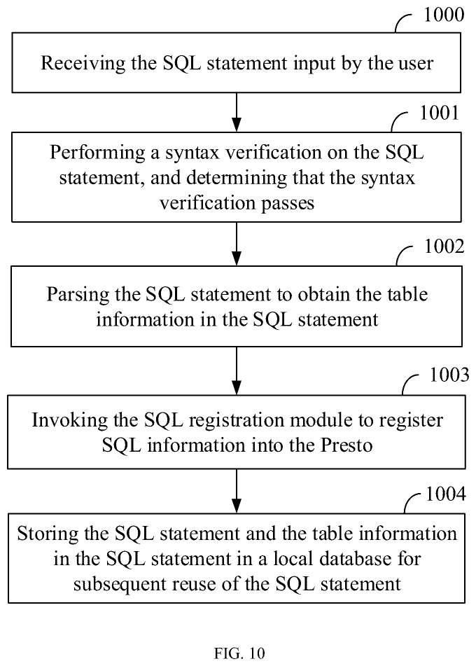

In the implementation, as shown in FIG. 10, taking the data source with which a connection is established as a data source of a SQL statement type as an example, the embodiment provides a flow for connecting a SQL statement data source to illustrate that when the data source is a data source of a SQL statement type, how to obtain the data source and establish a connection with the data source based on the connection information of the data source. The implementation process of this flow is as follows.

Step 1000: receiving the SQL statement input by the user.

During the implementation, in the embodiment, the SQL statement input by the user is received and the input SQL statement is determined as a data source of the SQL statement type.

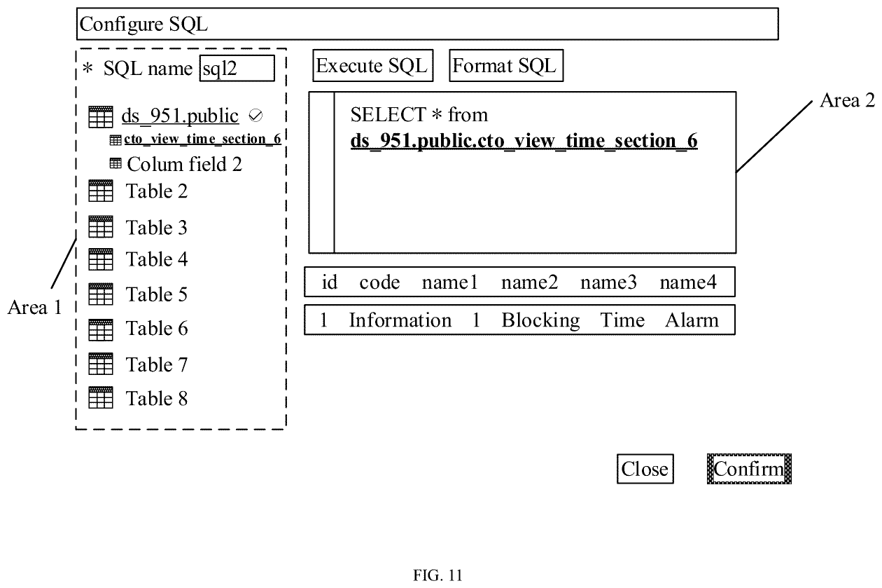

During the implementation, the syntax of the conventional SQL is “SELECT query field FROM table name WHERE condition GROUP BY” and other contents. In the embodiment, the user only needs to replace the table name (“ID”. “Schema” and table information) in the conventional SQL with the specified format, such as [“ID”. “Schema”. “Table Name”], to achieve the data query between multiple data sources. The “ID” refers to the data source ID specified by the user, and the “Schema” is a mode. Different data source types correspond to different Schemas. The data source of the database type has its own schema. Other manners such as the interface data source can be specified with a name. In this implementation, the mode of the specified interface is Schema. The “Table name” refers to a name of a table in the database. Other manners such as the interface data source is an interface name defined by the user. As shown in FIG. 11, the embodiment further provides an operation interface for configuring the SQL data source. According to the table information of the data source in the area 1 on the left side of the interface, the user can enter the SQL statement in the area 2 in the specified format based on each piece of displayed table information, thereby making the operation interface more convenient.

Step 1001: performing a syntax verification on the SQL statement, and determining that the syntax verification passes.

During the implementation, the user clicks to execute the SQL to invoke the SQL verification module, and the SQL execution result is returned. After the user sees that the previewed result is correct, the user performs the subsequent steps, otherwise the SQL statement is modified. The SQL verification module invokes the Presto to execute the SQL statement. After the execution is successful, the SQL result set is returned and encapsulated to be returned to the user. If the execution is failed, an error message is returned to the user to prompt the user to modify the SQL statement. After passing through the SQL verification module, the accuracy of the SQL can be guaranteed.

Step 1002: parsing the SQL statement to obtain the table information in the SQL statement.

During the implementation, a connection with a data source of a SQL statement type is established based on the SQL statement and the table information in the SQL statement.

During the implementation, the user saves the SQL, and the backend service may invoke the SQL parsing module to parse out the table information in the SQL statement, including but not limited to at least one of: a data source identifier to which a table belongs, a table field name, a column field name, or a field type of a column field.

Through the SQL parsing module, an attribute name, an attribute type, an attribute remark and other information of the registration “table” are parsed out. During the implementation, information such as a data source identifier, a table field name, a column field name, and a field type of a column field to which the table belongs can be parsed out.

In the implementation, a structure of a SQL is “SELECT attribute name FROM table name WHERE condition GROUP BY grouping attribute HAVING grouping condition”, in which the SQL statement(s) can still be nested in FROM and WHERE. Assuming that SELECT attribute name FROM table name WHERE condition GROUP BY grouping attribute HAVING grouping condition in the outermost layer is the first layer, the SQL parsing module only needs to parse out a name, a data type, and remark information in the actual physical “table” corresponding to the attribute name in SELECT in the first layer. The FROM in the first layer describes the table information to which these attributes belong. There is no need to pay attention to conditions such as WHERE, GROUP, HAVING, etc. Since the SQL statement can be nested in the FROM, it is necessary to recursively parse the SELECT and FROM information in the FROM, thus forming a syntax tree, in which each layer of node(s) records the attribute(s) of each layer and the table information where it is located, and the leaf node(s) is used as the actual connected table information, the root nodes) are the actual tables to which the query attributes respectively belong. Next, it only needs to start from the leaf nodes and traverse to the root nodes to finally determine which “table” physical stored corresponds to the attribute to be queried by the SQL.

Optionally, the attribute in the embodiment can be understood as a table field name and a table field type, a column field name and a column field type, a library field name and a library field type, a data source name and a data source type, etc.

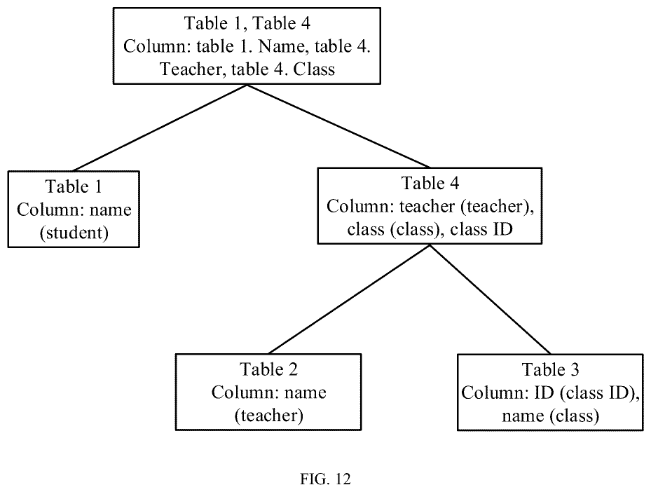

As shown in FIG. 12, the embodiment provides a schematic diagram of a SQL parsing syntax tree, in which there are three tables, namely a table 1, a table 2, and a table 3, corresponding to a student table, a teacher table, and a class table respectively. According to the above description method, the SQL is parsed out a syntax tree of three layers. The root node is used to query the name field in table 1, the teacher field and the class field in table 4. Then there are two child nodes at the root node, one is the table 1 and the other is the table 4. The table 4 is a temporary table in SQL, is a temporary table generated by the table 2 and the table 3, and describes the relationship between teachers and classes, and the queried fields of the table 4 are the teacher field renamed from the name field in the table 2, the ID field in the table 3, and the class field renamed from the name field in the table 3. Therefore, the table 4 has two child nodes, namely the table 2 and the table 3. The table 2 is queried with the name field and the table 3 is queried with the name field. It was finally determined that the fields queried by the SQL are the name field in the table 1, the name field in the table 2, and the name field in the table 3. The tree is traversed in the backward order starting from the leaf node at the lowest layer (the third layer). Each time it reaches the root node, the corresponding relationship between the column in the root node and the leaf node is found out, and the table relationship between the column of the root node and the leaf node is corresponded until the end of the traversal, so that the table information corresponding to all attributes can finally be obtained. The corresponding parsing results in the figure are: the student corresponding to the name field of “1”.public.student; the teacher corresponding to the name field of “2”.public.teacher; the class corresponding to the name field of “3”.schema.class.

Step 1003: invoking the SQL registration module to register SQL information into the Presto.

During the implementation, a connection with the data source of the SQL statement type is established according to the SQL statement and the table information in the SQL statement.

Due to the uncertain data volume of the SQL result, it is obviously impossible to save the SQL result into the memory. In the embodiment, the SQL result is registered in the Presto in the form of an interface. It only needs to provide an interface on the backend to return the execution SQL result, and place the interface in the above-mentioned preset format provided to the Presto in the source field. The field information in the table information in the SQL statement is added to the column field registered by the interface, and the Presto is invoked to reload the data source of the SQL statement. That is to say, in the embodiment, the SQL result is not stored, but the SQL result is returned through the provided interface, thereby effectively saving the physical memory resource of the server.

Step 1004: Storing the SQL statement and the table information in the SQL statement in a local database for subsequent reuse of the SQL statement.

During the implementation, the stored SQL statement and the SQL statement re-entered by the user can further be used to generate a nested SQL statement, and the generated nested SQL statement can be determined as the obtained data source of the SQL statement type, thereby realizing reuse of the stored SQL statement.

There is no need to store the execution result of the SQL statement, effectively saving the physical memory of the server.

In some embodiments, after parsing the SQL statement to obtain table information in the SQL statement, the SQL statement and the table information in the SQL statement can also be stored in a local database. A nested SQL statement is generated by using the stored SQL statement and the SQL statement input by the user, and the generated nested SQL statement is determined as the obtained data source of the SQL statement type.

When executing complex data combination query, by generating the nested SQL statement, the generated nested SQL statement is used as a data source, without need to use a result of the SQL statement executed every time as a data source to continue to increase the number of table connections, causing the complexity of multi-table associations to increase exponentially. By simplifying complex SQL statement, generating the nested SQL statement, and directly executing the final nested SQL statement, the resource occupied when querying complex data combination is reduced, so that the result set of SQL execution does not need to be stored in the physical space, but the SQL statement itself is reused as a data source, effectively improving the query efficiency.

The embodiment provides a visual data analysis method that can support multiple data sources, breaking the traditional single way of displaying data from a database. Not only can support multiple data sources, but can also aggregate (i.e., associate) data from multiple data sources together to achieve a SQL data source manner, but also the executed SQL result set does not need to be stored in physical space, and can still be reused as a data source. In addition, the SQL result is registered in the Presto, which provides ideas for expanding other businesses in the future, simplifies the complex SQL and is compatible with all types of complex SQL. The user-dragging page configuration is provided, and the coupling of the frontend and backend development is simplified. The dataset combined by the user can be used for the user data analysis to generate a knowledge graph to provide the reliable support for the development of various businesses of the enterprise.

The second aspect is the sharing of a connection relationship(s).

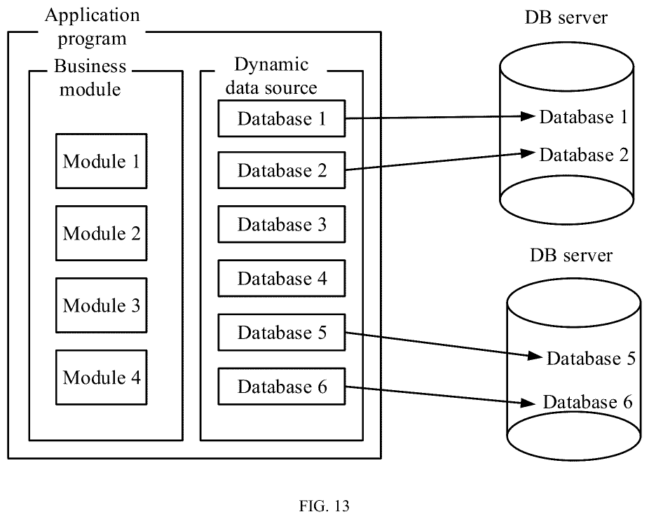

It should be noted that, as shown in FIG. 13, the embodiment provides a schematic diagram of a traditional business system-data source connection relationship. Currently, each business system needs to create and maintain its own data source, resulting in occupying the system resource (including the physical resource (such as the memory) of the application system, and occupying the public resource when accessing the database). Each business or application system cannot use the maximum resource of the database.

In order to solve the above problem, the embodiment provides a method for sharing a data source application. By connecting multiple business systems to the data sources through a shared data-source resource pool, the upper-layer business or application system no longer cares about and implements the data control layer, the application system no longer needs to access the database and perform data query, etc., which releases the resources occupied by the data control layer in the business system. In addition, the data source also can be registered into the shared data source application through the metadata description, and then the data query is performed through the metadata description language according to the business or application requirements.

The shared data source application in the embodiment can maintain the uniqueness of the resources of the same data source and make maximum use of the database's own connection pool. Since multiple business systems are involved, the high concurrent connections of the databases can be performed at the greatest extent according to the connection requirements of the business systems. At the same time, it provides rich aggregation-splitting and federated query capabilities (which can perform a query operation such as linked list association across data sources), and reduces the complexity of data processing by the upper-layer business or application system. At the same time, the shared data source application provides rich expansion tools, such as visual dataset editor, and data performance analysis, etc., to improve the user efficiency.

In some embodiments, the connection with each type of data source is established in the following manners: building a shared data source application according to a connection pool of each data source contained in each type of data source; and establishing a connection between each business system and each type of data source through the shared data source application, wherein the shared data source application provides a service for each business system to connect with each type of data source through an ability for integrating a connection with each type of data source.

Optionally, the shared data source application in the embodiment is a service-based application, which can be a Sass (Syntactically Awesome Stylesheets) application. The Sass application is a cascade style sheet language originally designed by Hampton Catlin and developed by Natalie Weizenbaum. After developing the initial version, Weizenbaum and Chris Eppstein continued to expand the functionality of the Sass through the SassScript. The SassScript is a small scripting language used in the Sass file.

In some embodiments, the connection between each business system and each type of data sources is established through the shared data source application. The specific implementation steps are as follows: establishing a connection between the shared data source application and each type of data source according to connection information of each data source described in a metadata; and establishing a connection between each type of data source connected with the shared data source application and each business system through the shared data source application.

During the implementation, for example, the data source registration (that is, establishing a connection) is performed through the metadata description. Taking the mysql as an example, there is the following description:
connector.name=mysql//data source type
connection-url=jdbc:mysql://192.168.52.1:3306//data source address
connection-user=root//user name
connection-password=123456//password.

Optionally, when registering the data source, whether the data source has been registered is determined. If it is registered, the data source of the tenant (or user) is bound. If it is not registered, the data source is dynamically created and the tenant (or user) data source relationship is bound.

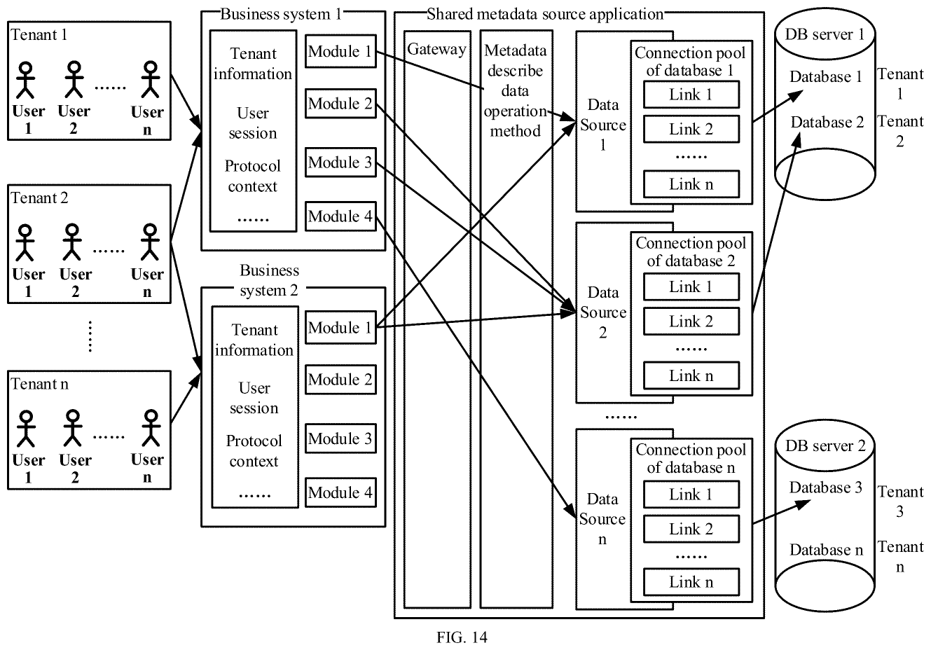

In some embodiments, the connection between each business system and each type of data source is established through the shared data source application. As shown in FIG. 14, the embodiment provides a schematic diagram of an architectural of a connection between each business system and each data source. Based on the schematic diagram, the following process is implemented: receiving an access requirement of each business system through the shared data source application; determining a connection pool of a target data source corresponding to each business system according to the access requirement of each business system and a number of connections in a connection pool of each data source; and establishing a connection with the data source of the SQL statement type according to the SQL statement and the table information in the SQL statement. The connection pool represents the technology of creating and managing a buffer pool of connections that can be used by any thread that needs them.

Optionally, as shown in FIG. 14, each business system can also be shared with multiple tenants through the multi-tenant technology. The multi-tenancy technology, or multi-leasing technology, is a software architecture technology that explores and implements how to share the same system or program component in a multi-user environment and still ensure that isolation of data between users.

In some embodiments, based on the above architecture, when multiple tenants or users access the same one database at the same time, a connection is established through http. The tenant or user names are first determined and whether the tenants or the users have access permissions to the database are determined. If having the access permissions, the JDBC accesses the search engine or the Presto in the embodiment can be used to process the data in the database, and the processing result is returned to the business system.

In some embodiments, the operation instruction sent by the business system in the form of metadata is received through the shared data source application. At least one operation of aggregation, filtering, or query is performed on the data source corresponding to the operation instruction. The metadata is information that mainly describes a data attribute(s) and is used to support a function(s) such as indicating the storage location, historical data, resource search, and file record, etc. Optionally, all operations based on the shared data source application will be recorded in the log. Each business or application system in the embodiment can process and sort out, e.g., aggregate, filter, the original data in the database, or query data from multiple data sources first, and then perform data processing at the code level. The shard data source application provides rich aggregation, filtering, federation and visualization capabilities, which can greatly reduce developers' code writing and error rates.

During the implementation, the application system can access the data source table through an API interface and directly return the query result. For example, the query information is as follows through a query in the form of metadata description:

```
{
      “id”: “1971”,
      “row”: [{
        “caption”: “code”,
        “colType”: “character”,
        “filter”: {
          “componentType”: “conditionInput”,
          “config”: {
            “joinType”: “or”,
            “conditions”: [{
              “conditionValue”: “=”,
              “value”: “energy-efficiency management platform”
            }]
          }
        },
        “itemType”: “dimension”,
        “name”: “code”,
        “owner”: “e2ff664bcb3d”,
        “pathId”: “f_r9FILrmv.204.public.cto_view_time_section_6.code”,
        “remark”: “”
      }],
        “column”: [{
        “caption”: “id”,
        “colType”: “bigint”,
        “itemType”: “measure”,
        “name”: “id”,
        “owner”: “e2ff664bcb3d”,
        “pathId”: “f_0wcT1QY8.204.public.cto_view_time_section_6.id”,
        “remark”: “”
      }],
    “filter”: [{
    “caption”: “create_time (quarter) ”,
    “colType”: “quarter”,
    “itemType”: “datetime”,
    “name”: “create_time”,
    “owner”: “e2ff664bcb3d”,
    “pathId”: “f_mxkl9Ky6.204.public.cto_view_time_section_6.create_time_quarter”,
    “remark”: “”
  }],
  “order”: [ ],
  “limit”: 1000
}.
```

The first-level description key is as follows, including:
row: which describes an account, and is resources, i.e., “group by” in the sql, that can be classified or grouped when aggregation;
column: which describes resources, i.e., “max” and “sum”, etc., in the sql, that need to be aggregated;
filter: which describes a resource(s), i.e., “where” in the sql, that need to be filtered;
order: which describes a resource(s), i.e., “order” in the sql, that need to be sorted; and limit: which describes the number of items, i.e., “limit” in the sql, that need to be queried.

The second-level description key is as follows, including:
Caption: which describes a remark of a resource field, etc.;
ColType: which describes a database type of a resource field;
ItemType: which describes a resource field being a string, a number or time;
Name: which describes original naming of a resource field;
Owner: which describes unique mapping of a resource field;
pathId: which describes a source (data source, schema, database table, field) of this resource;
remark: which describes a custom letter remark.

The filter describes filtering as follows, including:
componentType: which describes a type of filtering;
config: which describes a configuration of filtering;
joinType: which describes a relationship between multiple filtering conditions;
conditions: which describes a matching rule of filtering;
conditionValue: which describes a formula of filtering;
value: which describes a value of filtering.

In some embodiments, in the embodiment, a binding relationship between tenants and data sources can also be established to facilitate the later system maintenance. Optionally, the corresponding relationship among the tenant ID, user ID, and data source ID can be established, and further, the corresponding relationship among the data source ID, data source type, data source IP, data source port, database name, user name, password, and schema can be established, which will not be overly limited in the embodiment.

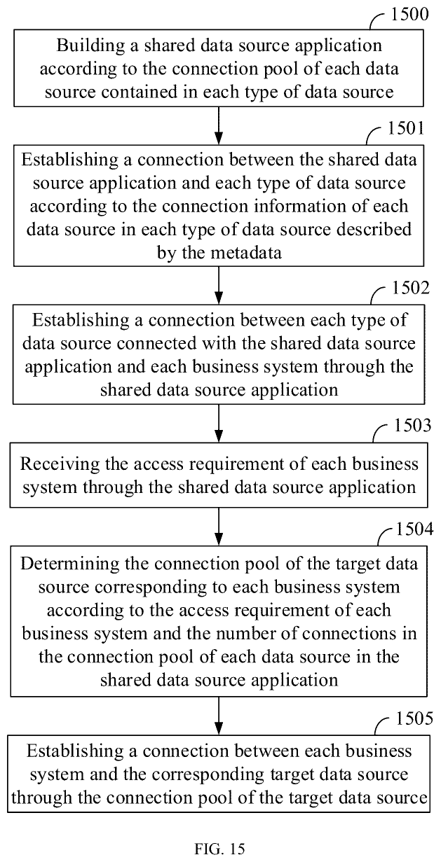

As shown in FIG. 15, the embodiment further provides an implementation process for sharing data sources. The specific implementation steps of this process are as follows.

Step 1500: building a shared data source application according to the connection pool of each data source contained in each type of data source.

The shared data source application provide various business systems with services to connect to various types of data sources through the ability for integrating connections with various types of data sources.

Step 1501: establishing a connection between the shared data source application and each type of data source according to the connection information of each data source in each type of data source described by the metadata.

Step 1502: establishing a connection between each type of data source connected with the shared data source application and each business system through the shared data source application.

Step 1503: receiving the access requirement of each business system through the shared data source application.

Step 1504: determining the connection pool of the target data source corresponding to each business system according to the access requirement of each business system and the number of connections in the connection pool of each data source in the shared data source application.

During the implementation, each independent business or application system may occupy a certain amount of resources for the same database. For example, the number of databases connected to the database connection pool is limited. In the embodiment, the maximum utilization of database resources is achieved through the shared data source application, the running environment resources of the upper-layer business or application system are reduced, and the development complexity of the upper-layer business or application system is reduced.

Step 1505: establishing a connection between each business system and the corresponding target data source through the connection pool of the target data source.

Since the business or application systems often connect to the same data source at the same time, and these business or application systems are usually independent, they need to be independently developed to realize the connection with and the operation on the database, and consume a certain amount of system resources. In the embodiment, the shared data source application is used to centrally manage, monitor, and provide services. By the ability for integrating all database connections, and by limiting current and fusing according to the actual situation of the business system, the full resource capabilities of the database is maximized. The shared data source application provides powerful data memory computing capabilities, and transforms the original single point calculation of large amounts of data in the business or application systems into a distributed processing manner in the high-speed memory. In addition, databases are usually sensitive and have high security requirements. The same one database server needs to open network connection permissions to each business or application system, which causes high maintenance costs. However, in the embodiment, the shared data source application is used to manage database resources, which can guarantee the security of database services. The shared data source application further provides a language based on the metadata description. Developers or business personnel who do not know the SQL language can implement business data operations through the simple language description.

In the embodiment, connections with various types of data sources are established. From the perspective of the connection architecture of each application system or business system with various types of data sources, through the centralized layout of the shared data source application, various application systems and various types of data sources are connected through the shared data source resource pool(s). When it is determined that an application system establishes a connection with a data source through the resource pool of the data source in the shared data source resource pool, the connection information of the data source can be used for establishing a connection with the data source. On one hand, it can maximize the full resource capabilities of the database. On the other hand, it can query and analyze various types of data in real time, display various data sources through the visual page, generate a target dataset by the association operation of the user on multiple displayed tables on the visual page, and display the target dataset visually.

For example, based on the same inventive concept, the embodiment of the present disclosure further provides a visual data analysis system, because this system is the system in the method in the embodiment of the present disclosure, and the principle of solving the problem of the system is the same as that of the method, the implementation of the system can be found in the implementation of the method, and the repetitive parts will not be repeated.

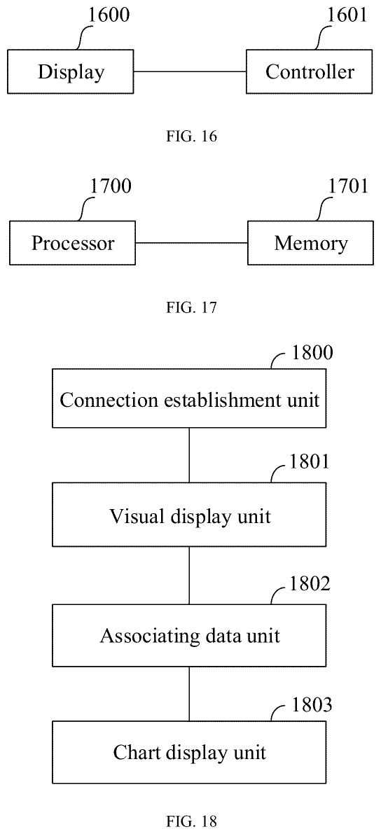

As shown in FIG. 16, the system includes a display 1600 and a controller 1601.

The display 1600 is configured to implement a human-computer interaction with a user through an interactive interface and display a visual page.

The controller 1601 is configured to perform the following steps based on the human-computer interaction: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

As an optional implementation, the controller 1601 is specifically configured to obtain multiple types of data sources through any one or more of following manners: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the controller 1601 is specifically configured to obtain a data source of a corresponding type according to the parameter information through any one or more of the following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the controller 1601 is specifically configured to: obtain a file in a FTP server by means of a SFTP, and determine the file obtained as a data source of a FTP type.

As an optional implementation, the controller 1601 is specifically configured to: receive a SQL statement executed by the user on a data source with which a connection is made, and determine the executed SQL statement as a data source of a SQL statement type.

As an optional implementation, the controller 1601 is specifically configured to: establish a connection with each type of data source according to connection information of each type of data source.

As an optional implementation, the controller 1601 is specifically configured to: write the connection information of each type of data source into a configuration file of a distributed query engine; and when starting the distributed query engine, establish, according to the connection information of each type of data source in the configuration file, the connection with each type of data source.

As an optional implementation manner, when the data source is a data source of a database type, the controller 1601 is specifically configured to: establish a connection with the data source of the database type according to a database parameter, wherein the database parameter represents a parameter required to connect with a database.

As an optional implementation manner, when the data source is a data source of an interface type, the controller 1601 is specifically configured to: run an interface according to an interface parameter to obtain JSON data, and parse the JSON data to obtain a data source parameter; and establish a connection with the data source of the interface type according to the data source parameter parsed and the interface parameter.

As an optional implementation manner, when the data source is a data source of a text type, the controller 1601 is specifically configured to: determine a data source parameter according to a data source stored in a file storage server; and establish a connection with the data source of the interface type according to a server parameter of the file storage server and the data source parameter.

As an optional implementation manner, the data source parameter includes at least one of a data source identifier, a type of data source, a library field, a table field, a column field, or a field type of a column field.

As an optional implementation manner, when the data source is a data source of a SQL statement type, the controller 1601 is specifically configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation manner, after parsing the SQL statement to obtain table information in the SQL statement, the controller 1601 is specifically configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the controller 1601 is specifically configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the controller 1601 is specifically configured to: establish a connection between the shared data source application and each type of data source according to connection information of each data source described in a metadata; and establish a connection between each type of data source connected with the shared data source application and each business system through the shared data source application.

As an optional implementation, the controller 1601 is specifically configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation manner, after the establishing a connection between each business system and each type of data source through the shared data source application, the controller 1601 is specifically configured to: receive an operation instruction sent by the business system in a form of a metadata through the shared data source application; and perform at least one operation of aggregation, filtering, or query on a data source corresponding to the operation instruction.

As an optional implementation, the controller 1601 is specifically configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the controller 1601 is specifically configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the controller 1601 is specifically configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the controller 1601 is specifically configured to: determine a chart type specified by the user and a target data column in the target dataset; use the target data column as chart data corresponding to the chart type, and use a chart component to draw a chart corresponding to the chart type; and display the drawn chart on the visual page.

For example, based on the same inventive concept, the embodiment of the present disclosure further provides a visual data analysis device, because this device is the device in the method in the embodiment of the present disclosure, and the principle of solving the problem of the device is the same as that of the method, so the implementation of the device can be referred to the implementation of the method, and repeated details will not be repeated.

As shown in FIG. 17, the device includes a processor 1700 and a memory 1701. The memory 1701 is configured to store programs executable by the processor 1700. The processor 1700 is configured to read the programs in the memory 1701 and perform the following steps: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

As an optional implementation, the processor 1700 is specifically configured to obtain multiple types of data sources through any one or more of following manner: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the processor 1700 is specifically configured to obtain a data source of a corresponding type according to the parameter information through any one or more of the following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the processor 1700 is specifically configured to: obtain a file in a FTP server by means of a SFTP, and determine the file obtained as a data source of a FTP type.

As an optional implementation, the processor 1700 is specifically configured to: receive a SQL statement executed by the user on a data source with which a connection is made, and determine the executed SQL statement as a data source of a SQL statement type.

As an optional implementation, the processor 1700 is specifically configured to: establish a connection with each type of data source according to connection information of each type of data source.

As an optional implementation, the processor 1700 is specifically configured to: write the connection information of each type of data source into a configuration file of a distributed query engine; and when starting the distributed query engine, establish, according to the connection information of each type of data source in the configuration file, the connection with each type of data source.

As an optional implementation, when the data source is a data source of a database type, the processor 1700 is specifically configured to: establish a connection with the data source of the database type according to a database parameter, wherein the database parameter represents a parameter required to connect with a database.

As an optional implementation manner, when the data source is a data source of an interface type, the processor 1700 is specifically configured to: run an interface according to an interface parameter to obtain JSON data, and parse the JSON data to obtain a data source parameter; and establish a connection with the data source of the interface type according to the data source parameter parsed and the interface parameter.

As an optional implementation, when the data source is a data source of text type, the processor 1700 is specifically configured to: determine a data source parameter according to a data source stored in a file storage server; and establish a connection with the data source of the interface type according to a server parameter of the file storage server and the data source parameter.

As an optional implementation manner, the data source parameter includes at least one of a data source identifier, a type of data source, a library field, a table field, a column field, or a field type of a column field.

As an optional implementation, when the data source is a data source of a SQL statement type, the processor 1700 is specifically configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation manner, after parsing the SQL statement to obtain table information in the SQL statement, the processor 1700 is specifically configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the processor 1700 is specifically configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the processor 1700 is specifically configured to: establish a connection between the shared data source application and each type of data source according to connection information of each data source described in a metadata; and establish a connection between each type of data source connected with the shared data source application and each business system through the shared data source application.

As an optional implementation, the processor 1700 is specifically configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation manner, after the establishing a connection between each business system and each type of data source through the shared data source application, the processor 1700 is specifically configured to: receive an operation instruction sent by the business system in a form of a metadata through the shared data source application; and perform at least one operation of aggregation, filtering, or query on a data source corresponding to the operation instruction.

As an optional implementation, the processor 1700 is specifically configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the processor 1700 is specifically configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the processor 1700 is specifically configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the processor 1700 is specifically configured to: determine a chart type specified by the user and a target data column in the target dataset; use the target data column as chart data corresponding to the chart type, and use a chart component to draw a chart corresponding to the chart type; and display the drawn chart on the visual page.

For example, based on the same inventive concept, the embodiment of the present disclosure also provides a visual data analysis apparatus, because this apparatus is the apparatus in the method in the embodiment of the present disclosure, and the principle of solving the problem of the device is the same as that of the method, so the implementation of the device can be referred to the implementation of the method, and repeated details will not be repeated.

As shown in FIG. 18, the device includes: a connection establishment unit 1800 configured to obtain multiple types of data sources, and establishing a connection with each type of data source, wherein the type of data source is used to represent a source from which data is obtained; a visual display unit 1801 configured to display, through a visual page, each piece of table information contained in each type of data source with which the connection is made; an associating data unit 1802 configured to, in response to an association operation of a user on multiple tables that are displayed, generate a target dataset according to an association relationship between the multiple tables indicated by the association operation; a chart display unit 1803 configured to display the target dataset on the visual page by means of a chart.

As an optional implementation, the connection establishment unit 1800 is specifically configured to obtain multiple types of data sources through any one or more of following manner: receiving parameter information input by the user, and obtaining a data source of a corresponding type according to the parameter information; obtaining a data source of a corresponding type through a file transfer protocol; or using an executed structured query language (SQL) statement as an obtained data source of a corresponding type.

As an optional implementation, the connection establishment unit 1800 is specifically configured to obtain data source of a corresponding type according to the parameter information through any one or more of the following manners: receiving a database parameter input by the user, and obtaining a data source of a database type according to the database parameter; or, receiving an interface parameter input by the user, and obtaining a data source of an interface type according to the interface parameter; or, obtaining text data uploaded by the user, and determining text data named by the user as a data source of a text type; or, receiving a Redis parameter input by the user, and obtaining a data source of a Redis cache type according to the Redis parameter; or, receiving a SQL statement input by the user, and determining the SQL statement input as a data source of a SQL statement type.

As an optional implementation, the connection establishment unit 1800 is specifically configured to: obtain a file in a FTP server by means of a SFTP, and determine the file obtained as a data source of a FTP type.

As an optional implementation, the connection establishment unit 1800 is specifically configured to: receive a SQL statement executed by the user on a data source with which a connection is made, and determine the executed SQL statement as a data source of a SQL statement type.

As an optional implementation, the connection establishment unit 1800 is specifically configured to: establish a connection with each type of data source according to connection information of each type of data source.

As an optional implementation, the connection establishment unit 1800 is specifically configured to: write the connection information of each type of data source into a configuration file of a distributed query engine; and when starting the distributed query engine, establish, according to the connection information of each type of data source in the configuration file, the connection with each type of data source.

As an optional implementation manner, when the data source is a data source of a database type, the connection establishment unit 1800 is specifically configured to: establish a connection with the data source of the database type according to a database parameter, wherein the database parameter represents a parameter required to connect with a database.

As an optional implementation manner, when the data source is a data source of an interface type, the connection establishment unit 1800 is specifically configured to: run an interface according to an interface parameter to obtain JSON data, and parse the JSON data to obtain a data source parameter; and establish a connection with the data source of the interface type according to the data source parameter parsed and the interface parameter.

As an optional implementation manner, when the data source is a data source of a text type, the connection establishment unit 1800 is specifically configured to: determine a data source parameter according to a data source stored in a file storage server; and establish a connection with the data source of the interface type according to a server parameter of the file storage server and the data source parameter.

As an optional implementation manner, the data source parameter includes at least one of a data source identifier, a type of data source, a library field, a table field, a column field, or a field type of a column field.

As an optional implementation manner, when the data source is a data source of a SQL statement type, the connection establishment unit 1800 is specifically configured to: perform a syntax verification on a SQL statement, and after determining that the syntax verification passes, parse the SQL statement to obtain table information in the SQL statement; and establish a connection with the data source of the SQL statement type according to the SQL statement and the table information in the SQL statement.

As an optional implementation manner, after parsing the SQL statement to obtain table information in the SQL statement, the connection establishment unit 1800 is specifically configured to: store the SQL statement and the table information in the SQL statement in a local database; and generate a nested SQL statement using the stored SQL statement and a SQL statement input by the user, and determine the generated nested SQL statement as an obtained data source of the SQL statement type.

As an optional implementation, the connection establishment unit 1800 is specifically configured to: build a shared data source application according to a connection pool of each data source contained in each type of data source; and establish a connection between each business system and each type of data source through the shared data source application, wherein the shared data source application provides a service for each business system to connect with each type of data source through an ability for integrating a connection with each type of data source.

As an optional implementation, the connection establishment unit 1800 is specifically configured to: establish a connection between the shared data source application and each type of data source according to connection information of each data source described in a metadata; and establish a connection between each type of data source connected with the shared data source application and each business system through the shared data source application.

As an optional implementation, the connection establishment unit 1800 is specifically configured to: receive an access requirement of each business system through the shared data source application; determine a connection pool of a target data source corresponding to each business system according to the access requirement of each business system and a number of connections in a connection pool of each data source; and establish a connection between each business system and a corresponding target data source through the connection pool of the target data source.

As an optional implementation manner, after the establishing a connection between each business system and each type of data source through the shared data source application, the device further includes an operation unit configured to: receive an operation instruction sent by the business system in a form of a metadata through the shared data source application; and perform at least one operation of aggregation, filtering, or query on a data source corresponding to the operation instruction.

As an optional implementation, the associating data unit 1802 is specifically configured to: in response to a dragging instruction of the user for the multiple tables displayed, determine table information of each target table corresponding to the dragging instruction; and receive an association relationship between multiple target tables input by the user, and generate a target dataset according to the table information of each target table and the association relationship.

As an optional implementation, the associating data unit 1802 is specifically configured to: determine first fields, that are the same, between the multiple target tables and second fields that are retained after the multiple target tables are associated according to the association relationship; and generate a SQL statement according to the table information of each target table, the first fields and the second fields, and execute the SQL statement to obtain the target dataset.

As an optional implementation, the associating data unit 1802 is specifically configured to: receive a filtering condition input by the user, wherein the filtering condition is used to filter data in multiple target tables; and generate a target dataset according to the filtering condition, table information of the multiple target tables, and the association relationship between the multiple target tables.

As an optional implementation, the chart display unit 1803 is specifically configured to: determine a chart type specified by the user and a target data column in the target dataset; use the target data column as chart data corresponding to the chart type, and use a chart component to draw a chart corresponding to the chart type; and display the drawn chart on the visual page.

Based on the same inventive concept, embodiments of the present disclosure further provide a computer storage medium on which a computer program is stored. The program is used to implement the following steps when executed by a processor: obtaining multiple types of data sources, and establishing a connection with each type of data source, wherein the type of data source is used to represent a source from which data is obtained; displaying, through a visual page, each piece of table information contained in each type of data source with which the connection is made; in response to an association operation of a user on multiple tables that are displayed, generating a target dataset according to an association relationship between the multiple tables indicated by the association operation; and displaying the target dataset on the visual page by means of a chart.

It should be understood by those skilled in the art that the embodiments of the present disclosure may be provided as a process, system, or computer program product. Therefore, the present disclosure may take the form of a complete hardware embodiment, a complete software embodiment, or a combination of software and hardware embodiments. Moreover, the present disclosure may take the form of a computer program product implemented on one or more computer-available storage media (including, but not limited to, disk memory and optical memory, etc.) containing computer-usable program code.

The present disclosure is described with reference to the flow diagram and/or block diagram of the method, device (system), and the computer program product according to the embodiments of the present disclosure. It should be understood that each process and/or block in the flow diagram and/or block diagram, as well as the combination of the process and/or block in the flow diagram and/or block diagram, can be implemented by computer program instructions. These computer program instructions may be provided to the processor of a general-purpose computer, a specialized computer, an embedded processing machine, or other programmable data processing device to produce a machine such that instructions executed by the processor of the computer or other programmable data processing device produce a device used to implement the functions specified in one or more processes of the flow diagram and/or one or more blocks of the block diagram.

These computer program instructions may also be stored in the computer-readable memory capable of directing a computer or other programmable data-processing device to behave in a particular manner, so that the instructions stored in the computer's readable memory produce a manufactured product that includes a directive device that implements the functions specified in one or more processes of the flow diagram and/or one or more blocks of the block diagram.

These computer program instructions may also be loaded onto a computer or other programmable data processing device such that a series of operational steps are performed on the computer or other programmable device to produce computer-implemented processing, so that the instructions executed on the computer or other programmable device provide steps for implementing the function specified in one or more processes of the flow diagram and/or one or more blocks of the block diagram.

Obviously, those skilled in the art may make various alterations and variations to the present disclosure without departing from the spirit and scope of the present disclosure. Thus, if these modifications and variations of the present disclosure fall within the scope of the claims of the present disclosure and its equivalents, the present disclosure is also intended to include such modifications and variations.

1. A visual data analysis method, comprising:
obtaining multiple types of data sources, and establishing a connection with each type of data source, wherein the type of data source is used to represent a source from which data is obtained;
displaying, through a visual page, each piece of table information contained in each type of data source with which the connection is made;
in response to an association operation of a user on multiple tables that are displayed, generating a target dataset according to an association relationship between the multiple tables indicated by the association operation; and
displaying the target dataset on the visual page by means of a chart.

2. The method according to claim 1, wherein obtaining multiple types of data sources through any one or more of following manners:
receiving parameter information input by the user, and obtaining a data source of a corresponding type according to the parameter information;
obtaining a data source of a corresponding type through a file transfer protocol; or
using an executed structured query language (SQL) statement as an obtained data source of a corresponding type.

3. The method according to claim 2, wherein obtaining a data source of a corresponding type according to the parameter information through any one or more of following manners:
receiving a database parameter input by the user, and obtaining a data source of a database type according to the database parameter; or,
receiving an interface parameter input by the user, and obtaining a data source of an interface type according to the interface parameter; or,
obtaining text data uploaded by the user, and determining text data named by the user as a data source of a text type; or,
receiving a Redis parameter input by the user, and obtaining a data source of a Redis cache type according to the Redis parameter; or,
receiving a SQL statement input by the user, and determining the SQL statement input as a data source of a SQL statement type.

4. The method according to claim 2, wherein the obtaining a data source of a corresponding type through a file transfer protocol, comprises:
obtaining a file in a file transfer protocol (FTP) server by means of a secret file transfer protocol (SFTP), and determining the file obtained as a data source of a FTP type.

5. The method according to claim 2, wherein the using an executed SQL statement as an obtained data source of a corresponding type, comprises:
receiving a SQL statement executed by the user on a data source with which a connection is made, and determining the executed SQL statement as a data source of a SQL statement type.

6. The method according to claim 1, wherein the establishing a connection with each type of data source, comprises:
establishing a connection with each type of data source according to connection information of each type of data source.

7. The method according to claim 6, wherein the establishing a connection with each type of data source according to connection information of each type of data source, comprises:
writing the connection information of each type of data source into a configuration file of a distributed query engine; and
when starting the distributed query engine, establishing, according to the connection information of each type of data source in the configuration file, the connection with each type of data source.

8. The method according to claim 6, wherein when the data source is a data source of a database type, the establishing a connection with each type of data source according to connection information of each type of data source, comprises:
establishing a connection with the data source of the database type according to a database parameter, wherein the database parameter represents a parameter required to connect with a database.

9. The method according to claim 6, wherein when the data source is a data source of an interface type, the establishing a connection with each type of data source according to connection information of each type of data source, comprises:
running an interface according to an interface parameter to obtain Java script object notation (JSON) data, and parsing the JSON data to obtain a data source parameter; and
establishing a connection with the data source of the interface type according to the data source parameter parsed and the interface parameter; or
when the data source is a data source of a text type, the establishing a connection with each type of data source according to connection information of each type of data source, comprises:
determining a data source parameter according to a data source stored in a file storage server; and
establishing a connection with the data source of the interface type according to a server parameter of the file storage server and the data source parameter.

10. (canceled)

11. The method according to claim 9, wherein the data source parameter comprises at least one of a data source identifier, a type of data source, a library field, a table field, a column field, or a field type of a column field.

12. The method according to claim 6, wherein when the data source is a data source of a SQL statement type, the establishing a connection with each type of data source according to connection information of each type of data source, comprises:
performing a syntax verification on a SQL statement, and after determining that the syntax verification passes, parsing the SQL statement to obtain table information in the SQL statement; and
establishing a connection with the data source of the SQL statement type according to the SQL statement and the table information in the SQL statement.

13. The method according to claim 12, wherein after parsing the SQL statement to obtain table information in the SQL statement, the method further comprises:
storing the SQL statement and the table information in the SQL statement in a local database; and
generating a nested SQL statement using the stored SQL statement and a SQL statement input by the user, and determining the generated nested SQL statement as an obtained data source of the SQL statement type.

14. The method according to claim 1, wherein the establishing a connection with each type of data source, comprises:
building a shared data source application according to a connection pool of each data source contained in each type of data source; and
establishing a connection between each business system and each type of data source through the shared data source application, wherein the shared data source application provides a service for each business system to connect with each type of data source through an ability for integrating a connection with each type of data source.

15. The method according to claim 14, wherein the establishing a connection between each business system and each type of data source through the shared data source application, comprises:
establishing a connection between the shared data source application and each type of data source according to connection information of each data source described in a metadata; and
establishing a connection between each type of data source connected with the shared data source application and each business system through the shared data source application; or
receiving an access requirement of each business system through the shared data source application;
determining a connection pool of a target data source corresponding to each business system according to the access requirement of each business system and a number of connections in a connection pool of each data source; and
establishing a connection between each business system and a corresponding target data source through the connection pool of the target data source.

16. (canceled)

17. The method according to claim 14, wherein after the establishing a connection between each business system and each type of data source through the shared data source application, the method further comprises:
receiving an operation instruction sent by the business system in a form of a metadata through the shared data source application; and
performing at least one operation of aggregation, filtering, or query on a data source corresponding to the operation instruction.

18. The method according to claim 1, wherein in response to an association operation of a user on multiple tables that are displayed, the generating a target dataset according to an association relationship between the multiple tables indicated by the association operation, comprises:
in response to a dragging instruction of the user for the multiple tables displayed, determining table information of each target table corresponding to the dragging instruction; and
receiving an association relationship between multiple target tables input by the user, and generating a target dataset according to the table information of each target table and the association relationship.

19. The method according to claim 18, wherein the generating a target dataset according to the table information of each target table and the association relationship, comprises:
determining first fields, that are the same, between the multiple target tables and second fields that are retained after the multiple target tables are associated according to the association relationship; and
generating a SQL statement according to the table information of each target table, the first fields and the second fields, and executing the SQL statement to obtain the target dataset.

20. The method according to claim 18, wherein the generating a target dataset according to the table information of each target table and the association relationship, further comprises:
receiving a filtering condition input by the user, wherein the filtering condition is used to filter data in multiple target tables; and
generating a target dataset according to the filtering condition, table information of the multiple target tables, and the association relationship between the multiple target tables.

21. The method according to claim 1, wherein the displaying the target dataset on the visual page by means of a chart, comprises:
determining a chart type specified by the user and a target data column in the target dataset;
using the target data column as chart data corresponding to the chart type, and using a chart component to draw a chart corresponding to the chart type; and
displaying the drawn chart on the visual page.

22. (canceled)

23. A visual data analysis device, comprising: a processor and a memory, wherein the memory is configured to store programs executable by the processor, and the processor is configured to read the programs in the memory and execute steps of the method according to claim 1.

24. (canceled)
